(19) United States
(12) Patent Application Publication
(10) Pub. No.: US 2025/0171571 A1
(43) Pub. Date: May 29, 2025

(54) MULTIMODAL ETHYLENE-BASED COPOLYMER COMPOSITIONS AND PROCESSES OF PRODUCING

(71) Applicant: Dow Global Technologies LLC, Midland, MI (US)

(72) Inventors: Philip P. Fontaine, Pearland, TX (US); Edmund M. Carnahan, Pearland, TX (US); Jerzy Klosin, Midland, MI (US); Mari S. Rosen, Houston, TX (US); Fawzi G. Hamad, Pearland, TX (US); Paul Balding, Lake Jackson, TX (US)

(73) Assignee: Dow Global Technologies LLC, Midland, MI (US)

(21) Appl. No.: 18/724,694

(22) PCT Filed: Dec. 29, 2022
(86) PCT No.: PCT/US2022/082567

§ 371 Date: Jun. 27, 2024

Related U.S. Application Data
(60) Provisional application No. 63/295,187, filed on Dec. 30, 2021.

(51) Int. Cl. C08F 210/16

(52) U.S. Cl. CPC C08F 210/16

(57) ABSTRACT

Embodiments of processes of making a multimodal ethylene-based copolymer may include contacting, in a solution polymerization reactor system at a reactor temperature of greater than or equal to 150° C., at least two olefinic monomers in the presence of at least a first catalyst to produce a bulk low molecular weight component and a second catalyst to produce a high molecular weight component. The multimodal ethylene-based copolymer may comprise a long chain branching frequency of from 1.0 to 1.8; a melt index of from 0.5 g/10 minutes (g/10 min) to 10.0 g/10 min; and a molecular weight distribution determined by GPC-LALLS CDF comprising greater than 8% of a high molecular weight fraction, wherein the high molecular weight fraction is computed by measuring an area fraction of a low angle light scattering (LALLS) detector chromatogram greater than 500,000 g/mol using GPC.

### CROSS-REFERENCE TO RELATED APPLICATIONS

This application claims the benefit of U.S. Provisional Application Ser. No. 63/295,187 filed Dec. 30, 2021, the entire disclosure of which is hereby incorporated herein by reference.

### TECHNICAL FIELD

Embodiments of the present disclosure generally relate to polymer compositions and more specifically relate to multimodal ethylene-based copolymer compositions and processes of producing the same.

### BACKGROUND

The use of polyolefin compositions in industries such as packaging applications is generally known. A variety of conventional methods may be employed to produce such polyolefin compositions. Various polymerization techniques using different catalyst systems have been employed to produce such polyolefin compositions suitable for packaging applications. However, despite the research efforts in developing compositions suitable for, in some embodiments, packaging applications, there is still a need for improved polyethylene compositions suitable for packaging applications that may have a good balance of physical properties and melt strength at desired polymer composition densities.

### SUMMARY

Melt strength and processability are correlated properties of polyethylene resins. In general, a higher melt strength provides for a polyethylene resin with improved processability.

Additionally, conventional polyethylene resins produced by conventional processes typically see a tradeoff between the resin's mechanical properties and melt strength. For example, conventional radical processes, which are known to be hazardous, produce low density polyethylenes (LDPE) that typically exhibit high melt strength but have poor mechanical properties. In contrast, linear low-density polyethylenes (LLDPE) made via solution or gas phase processes typically have poor melt strength but excellent mechanical properties.

Therefore, to increase processability, some amount of LDPE may typically be blended with LLDPE in order to improve the processability and melt strength of LLDPE resins. Unfortunately, the addition of LDPE leads to decreased the mechanical properties of the resulting blends when compared with pure LLDPE resin.

Accordingly, there are needs for solution polymerization processes that produce polyethylene resins that may have melt strengths comparable to polyethylene resins produced via a radical process. In particular, there are needs for solution polymerization processes that produce polyethylene resins that may have melt strengths comparable to LDPE resins produced via a radical process.

Embodiments of the present disclosure meet those needs by providing multimodal ethylene-based copolymers that comprise a bulk low molecular weight (LMW) ethylene-based component made by one catalyst or catalysts and a high molecular weight (HMW) ethylene-based component made by a different catalyst or catalysts. The multimodal ethylene-based copolymers described herein may possess long chain branching that, along with the HMW ethylene-based component, allows for melt strengths to be achieved that are comparable to or higher than various LDPEs produced via conventional processes. Consequently, the multimodal ethylene-based copolymers described herein may be used as blend components with LLDPEs in lesser amounts than what is needed for conventional LDPE resins, thereby leading to improved mechanical properties of the resulting LLDPE blends when compared to the mechanical properties in conventional LLDPE/LDPE blends. In embodiments, the multimodal ethylene-based copolymers are produced via a solution polymerization process.

Embodiments of this disclosure include processes of making a multimodal ethylene-based copolymer. In embodiments, the process includes contacting, in a solution polymerization reactor system at a first reactor temperature of greater than or equal to 150° C., at least two olefinic monomers in the presence of at least a first catalyst to produce a bulk low molecular weight component and a second catalyst to produce a high molecular weight (HMW) component. The multimodal ethylene-based copolymer includes a long chain branching frequency of from 0.3 to 1.0; a melt index of from 0.5 g/10 minutes (g/10 min) to 10.0 g/10 min, when measured according to ASTM D-1238 at 190° C. and 2.16 kg; and a molecular weight distribution determined by GPC low angle light scattering (LALLS) cumulative distribution fractions (CDF) comprising greater than 8% of a high molecular weight fraction, wherein the high molecular weight fraction is computed by measuring an area fraction of a low angle light scattering (LALLS) detector chromatogram greater than 500,000 g/mol using GPC.

### DETAILED DESCRIPTION

Embodiments of multimodal ethylene-based copolymer compositions and processes of producing the same will now be described. The ethylene-based polymers, of ethylene and optionally one or more co-monomers such as α-olefins, may comprise from at least 50 mole percent (mol %) monomer units derived from ethylene. All individual values and subranges encompassed by “from at least 50 mole percent” are disclosed herein as separate embodiments; for example, the ethylene based polymers may comprise at least 60 mole percent monomer units derived from ethylene; at least 70 mole percent monomer units derived from ethylene; at least 80 mole percent monomer units derived from ethylene; or from 50 to 100 mole percent monomer units derived from ethylene; or from 80 to 100 mole percent monomer units derived from ethylene.

### Processes

In embodiments, the multimodal ethylene-based copolymer compositions may be produced via a solution polymerization process. In embodiments, the process of making a multimodal ethylene-based copolymer may include contacting at least two olefinic monomers in the presence of a catalyst system comprising at least one low molecular weight catalyst and at least one high molecular weight catalyst in the solution polymerization reactor system.

In embodiments, the solution polymerization reactor system may include one or more reactors. In embodiments, the solution polymerization reactor system may be a single reactor system. In embodiments, the solution polymerization reactor system may be a dual reactor system. In embodiments that comprise a dual reactor system, the solution polymerization reactor system may include a first reactor and a second reactor. Such solution polymerization processes include using one or more conventional reactors such as loop reactors, isothermal reactors, adiabatic reactors, fluidized bed gas phase reactors, stirred tank reactors, batch reactors in parallel, series, or any combinations thereof, for example.

In embodiments, ethylene and at least one olefinic monomer may be polymerized in the presence of a catalyst to produce the multimodal ethylene-based copolymer compositions described herein. The olefinic monomer may be an α-olefin co-monomers. Typically, the α-olefin monomers have no more than 20 carbon atoms. For example, the α-olefin co-monomers may have 3 to 10 carbon atoms or 3 to 8 carbon atoms. Exemplary α-olefin co-monomers include, but are not limited to, propylene, 1-butene, I-pentene, 1-hexene, 1-heptene, 1-octene, 1-nonene, I-decene, and 4-methyl-1-pentene. For example, the one or more α-olefin co-monomers may be selected from the group consisting of propylene, 1-butene, 1-hexene, and 1-octene; or in the alternative, from the group consisting of 1-hexene and 1-octene. In embodiments, the α-olefin co-monomers and the process solvent may be purified with molecular sieves before introduction into the solution polymerization reactor system. The solvent, monomer, comonomers, and hydrogen may be combined and feed to the solution polymerization reactor system. Exemplary solvents include, but are not limited to, isoparaffins. For example, such solvents are commercially available under the name ISOPAR™ E from ExxonMobil Chemical. In embodiments, the combined feed may be temperature controlled to a temperature of from 5° C. to 50° C., from 5° C. to 25° C., from 5° C. to 10° C., from 10° C. to 50° C., from 10° C. to 25° C., or from 25° C. to 50° C.

The catalyst systems, described in the subsequent section in more detail, are utilized in the polymerization of olefins to produce the multimodal ethylene-based copolymer compositions described herein. As stated previously, the catalyst system in the solution polymerization reactor system may comprise at least one first catalyst that produces a bulk low molecular weight (LMW) ethylene-based component and at least one second catalyst that produces a high molecular weight (HMW) ethylene-based component.

In one embodiment, the multimodal ethylene-based copolymer composition may be produced, via a solution polymerization process, wherein ethylene, and optionally one or more α-olefins, are polymerized in the presence of a first catalyst to produce a bulk low molecular weight (LMW) ethylene-based component. As used herein, “bulk” may refer to a component that makes up greater than 50% of a composition, based on the overall weight of the composition. In one or more embodiments, the first catalyst may have a first catalyst efficiency of from 1,000 kg polymer/g metal to 30,000 kg polymer/g metal. In further embodiments, the first catalyst may have a low molecular weight catalyst efficiency of from 1,000 kg polymer/g metal to 25,000 kg polymer/g metal, from 1,000 kg polymer/g metal to 20,000 kg polymer/g metal, from 1,000 kg polymer/g metal to 15,000 kg polymer/g metal, from 1,000 kg polymer/g metal to 10,000 kg polymer/g metal, from 1,000 kg polymer/g metal to 5,000 kg polymer/g metal, from 5,000 kg polymer/g metal to 25,000 kg polymer/g metal, from 5,000 kg polymer/g metal to 20,000 kg polymer/g metal, from 5,000 kg polymer/g metal to 15,000 kg polymer/g metal, from 5,000 kg polymer/g metal to 10,000 kg polymer/g metal, from 10,000 kg polymer/g metal to 25,000 kg polymer/g metal, from 10,000 kg polymer/g metal to 20,000 kg polymer/g metal, from 10,000 kg polymer/g metal to 15,000 kg polymer/g metal, from 15,000 kg polymer/g metal to 25,000 kg polymer/g metal, from 15,000 kg polymer/g metal to 20,000 kg polymer/g metal, or from 1,000 kg polymer/g metal to 25,000 kg polymer/g metal.

In one embodiment, the multimodal ethylene-based copolymer composition may be produced, via a solution polymerization process, wherein ethylene and optionally one or more α-olefins are polymerized in the presence of a second catalyst to produce the high molecular weight (HMW) ethylene-based component. In one or more embodiments, the second catalyst may have a second efficiency of from 1,000 kg polymer/g metal to 100,000 kg polymer/g metal. In further embodiments, the second catalyst may have a second efficiency of from 1,000 kg polymer/g metal to 75,000 kg polymer/g metal, from 1,000 kg polymer/g metal to 50,000 kg polymer/g metal, or from 1,000 kg polymer/g metal to 25,000 kg polymer/g metal. In further embodiments, the second catalyst may have a second efficiency of from 1,000 kg polymer/g metal to 25,000 kg polymer/g metal, from 1,000 kg polymer/g metal to 20,000 kg polymer/g metal, from 1,000 kg polymer/g metal to 15,000 kg polymer/g metal, from 1,000 kg polymer/g metal to 10,000 kg polymer/g metal, from 1,000 kg polymer/g metal to 5,000 kg polymer/g metal, from 5,000 kg polymer/g metal to 25,000 kg polymer/g metal, from 5,000 kg polymer/g metal to 20,000 kg polymer/g metal, from 5,000 kg polymer/g metal to 15,000 kg polymer/g metal, from 5,000 kg polymer/g metal to 10,000 kg polymer/g metal, from 10,000 kg polymer/g metal to 25,000 kg polymer/g metal, from 10,000 kg polymer/g metal to 20,000 kg polymer/g metal, from 10,000 kg polymer/g metal to 15,000 kg polymer/g metal, from 15,000 kg polymer/g metal to 25,000 kg polymer/g metal, from 15,000 kg polymer/g metal to 20,000 kg polymer/g metal, or from 1,000 kg polymer/g metal to 25,000 kg polymer/g metal. In one or more embodiments, the second catalyst may exhibit a second reactivity ratio of less than 20. In further embodiments, the second catalyst may exhibit a second reactivity ratio of less than 20, less than 15, or less than 10. In further embodiments, the second catalyst may exhibit a first reactivity ratio of from 10 to 20, from 10 to 15, or from 15 to 20.

In one embodiment, the multimodal ethylene-based copolymer composition may be produced, via a solution polymerization process, in a dual reactor system, for example a dual loop reactor system, wherein ethylene, and optionally one or more α-olefins, are polymerized in the presence of the low molecular weight catalyst system, in a first reactor, to produce the bulk low molecular weight (LMW) ethylene-based component and ethylene, and optionally one or more α-olefins, are polymerized in the presence of the high molecular weight catalyst system, in a second reactor, to produce the high molecular weight (HMW) ethylene-based component. Additionally, one or more cocatalysts may be present. In another embodiment, the multimodal ethylene-based copolymer composition may be produced via a solution polymerization process, in a single reactor system, for example, a single loop reactor system, wherein ethylene, and optionally one or more α-olefins, are polymerized in the presence of the low molecular weight catalyst system and the high molecular weight catalyst system. Additionally, one or more cocatalysts may be present.

In embodiments, the solution polymerization reactor system may include one or more reactors that operate at a temperature greater than 150° C. In embodiments, the solution polymerization reactor system may include one or more reactors that operate at a temperature from 160° C. to 200° C., from 160° C. to 190° C., from 160° C. to 180° C., from 160° C. to 170° C., from 170° C. to 200° C., from 170° C. to 190° C., from 170° C. to 180° C., from 180° C. to 200° C., from 180° C. to 190° C., or from 190° C. to 200° C. Operating the solution polymerization reactor at elevated reactor temperatures (>150° C.) may increase production rate and decrease energy consumption while still producing the polyethylene product with an acceptable catalyst efficiency and process control.

The reactor monomer feed (ethylene) stream is pressurized via mechanical compressor to above reaction pressure at 525 psig. The solvent and comonomer (1-octene) feeds are pressurized via mechanical positive displacement pump to above reaction pressure at 525 psig.

Immediately following each fresh injection location, the feed streams are mixed with the circulating polymerization reactor contents with static mixing elements. The effluent from the polymerization reactor (containing solvent, monomer, comonomer, hydrogen, catalyst components, and molten polymer) exits the first reactor loop and passes through a control valve (responsible for maintaining the pressure of the first reactor at a specified target). As the stream exits the reactor it is contacted with water to stop the reaction. In addition, various additives such as antioxidants, could be added at this point. The stream then went through another set of static mixing elements to evenly disperse the catalyst kill and additives.

Following additive addition, the effluent (containing solvent, monomer, comonomer, hydrogen, catalyst components, and molten polymer) passed through a heat exchanger to raise the stream temperature in preparation for separation of the polymer from the other lower boiling reaction components. The stream then enters a two-stage separation and devolatization system where the polymer is removed from the solvent, hydrogen, and unreacted monomer and comonomer. The separated and devolatized polymer melt is pumped through a die specially designed for underwater pelletization, cut into uniform solid pellets, dried, and transferred into a box for storage.

### Catalyst Systems

Specific embodiments of catalyst systems that can, in one or more embodiments, be used to produce the multimodal ethylene-based copolymer compositions described herein will now be described. It should be understood that the catalyst systems of this disclosure may be embodied in different forms and should not be construed as limited to the specific embodiments set forth in this disclosure. Rather, embodiments are provided so that this disclosure will be thorough and complete, and will fully convey the scope of the subject matter to those skilled in the art.

The term “independently selected” is used herein to indicate that the R groups, such as, R¹, R², R³, R⁴, and R⁵ can be identical or different (e.g., R¹, R², R³, R⁴, and R⁵ may all be substituted alkyls or R¹ and R² may be a substituted alkyl and R³ may be an aryl, etc.). Use of the singular includes use of the plural and vice versa (e.g., a hexane solvent, includes hexanes). A named R group will generally have the structure that is recognized in the art as corresponding to R groups having that name. These definitions are intended to supplement and illustrate, not preclude, the definitions known to those of skill in the art.

The term “procatalyst” refers to a compound that has catalytic activity when combined with an activator. The term “activator” refers to a compound that chemically reacts with a procatalyst in a manner that converts the procatalyst to a catalytically active catalyst. As used herein, the terms “co-catalyst” and “activator” are interchangeable terms.

When used to describe certain carbon atom-containing chemical groups, a parenthetical expression having the form “(Cₓ-C_{y})” means that the unsubstituted form of the chemical group has from x carbon atoms to y carbon atoms, inclusive of x and y. For example, a (C₁-C₄₀)alkyl is an alkyl group having from 1 to 40 carbon atoms in its unsubstituted form. In some embodiments and general structures, certain chemical groups may be substituted by one or more substituents such as R^{S}. An R^{S} substituted version of a chemical group defined using the “(Cₓ-C_{y})” parenthetical may contain more than y carbon atoms depending on the identity of any groups R^{S}. For example, a “(C₁-C₄₀)alkyl substituted with exactly one group R^{S}, where R^{S} is phenyl (—C₆H₅)” may contain from 7 to 46 carbon atoms. Thus, in general when a chemical group defined using the “(Cₓ-C_{y})” parenthetical is substituted by one or more carbon atom-containing substituents R^{S}, the minimum and maximum total number of carbon atoms of the chemical group is determined by adding to both x and y the combined sum of the number of carbon atoms from all of the carbon atom-containing substituents R^{S}.

The term “substitution” means that at least one hydrogen atom (—H) bonded to a carbon atom or heteroatom of a corresponding unsubstituted compound or function group is replaced by a substituent (e.g. R^{S}). The term “persubstitution” means that every hydrogen atom (H) bonded to a carbon atom or heteroatom of a corresponding unsubstituted compound or functional group is replaced by a substituent (e.g., R^{S}). The term “polysubstitution” means that at least two, but fewer than all, hydrogen atoms bonded to carbon atoms or heteroatoms of a corresponding unsubstituted compound or functional group are replaced by a substituent.

The term “—H” means a hydrogen or hydrogen radical that is covalently bonded to another atom. “Hydrogen” and “—H” are interchangeable, and unless clearly specified mean the same thing.

The term “(C₁-C₄₀)hydrocarbyl” means a hydrocarbon radical of from 1 to 40 carbon atoms and the term “(C₁-C₄₀)hydrocarbylene” means a hydrocarbon diradical of from 1 to 40 carbon atoms, in which each hydrocarbon radical and each hydrocarbon diradical is aromatic or non-aromatic, saturated or unsaturated, straight chain or branched chain, cyclic (including mono- and poly-cyclic, fused and non-fused polycyclic, including bicyclic; 3 carbon atoms or more) or acyclic and is unsubstituted or substituted by one or more R^{S}.

In this disclosure, a (C₁-C₄₀)hydrocarbyl can be an unsubstituted or substituted (C₁-C₄₀)alkyl, (C₃-C₄₀)cycloalkyl, (C₃-C₂₀)cycloalkyl-(C₁-C₂₀)alkylene, (C₆-C₄₀)aryl, or (C₆-C₂₀)aryl-(C₁-C₂₀)alkylene. In some embodiments, each of the aforementioned (C₁-C₄₀)hydrocarbyl groups has a maximum of 20 carbon atoms (i.e., (C₁-C₂₀)hydrocarbyl) and embodiments, a maximum of 12 carbon atoms.

The terms “(C₁-C₄₀)alkyl” and “(C₁-Cis)alkyl” mean a saturated straight or branched hydrocarbon radical of from 1 to 40 carbon atoms or from 1 to 18 carbon atoms, respectively, that is unsubstituted or substituted by one or more R^{S}. Examples of unsubstituted (C₁-C₄₀)alkyl are unsubstituted (C₁-C₂₀)alkyl; unsubstituted (C₁-C₁₀)alkyl; unsubstituted (C₁-C₅)alkyl; methyl; ethyl; 1-propyl; 2-propyl; 1-butyl; 2-butyl; 2-methylpropyl; 1,1-dimethylethyl; 1-pentyl; 1-hexyl; 1-heptyl; 1-nonyl; and 1-decyl. Examples of substituted (C₁-C₄₀)alkyl are substituted (C₁-C₂₀)alkyl, substituted (C₁-C₁₀)alkyl, trifluoromethyl, and [C₄₅]alkyl. The term “[C₄₅]alkyl” (with square brackets) means there is a maximum of 45 carbon atoms in the radical, including substituents, and is, for example, a (C₂₇-C₄₀)alkyl substituted by one R^{S}, which is a (C₁-C₅)alkyl, respectively. Each (C₁-C₅)alkyl may be methyl, trifluoromethyl, ethyl, 1-propyl, 1-methylethyl, or 1,1-dimethylethyl.

The term “(C₆-C₄₀)aryl” means an unsubstituted or substituted (by one or more R^{S}) mono-, bi- or tricyclic aromatic hydrocarbon radical of from 6 to 40 carbon atoms, of which at least from 6 to 14 of the carbon atoms are aromatic ring carbon atoms, and the mono-, bi- or tricyclic radical comprises 1, 2, or 3 rings, respectively; wherein the 1 ring is aromatic and the 2 or 3 rings independently are fused or non-fused and at least one of the 2 or 3 rings is aromatic. Examples of unsubstituted (C₆-C₄₀)aryl are unsubstituted (C₆-C₂₀)aryl unsubstituted (C₆—Cis)aryl; 2-(C₁-C₅)alkyl-phenyl; 2,4-bis(C₁-C₅)alkyl-phenyl; phenyl; fluorenyl; tetrahydrofluorenyl; indacenyl; hexahydroindacenyl; indenyl; dihydroindenyl; naphthyl; tetrahydronaphthyl; and phenanthrene. Examples of substituted (C₆-C₄₀)aryl are substituted (C₁-C₂₀)aryl; substituted (C₆-C₁₈)aryl; 2,4-bis[(C₂₀)alkyl]-phenyl; polyfluorophenyl; pentafluorophenyl; and fluoren-9-one-1-yl.

The term “(C₃-C₄₀)cycloalkyl” means a saturated cyclic hydrocarbon radical of from 3 to 40 carbon atoms that is unsubstituted or substituted by one or more R^{S}. Other cycloalkyl groups (e.g., (Cₓ-C_{y})cycloalkyl) are defined in an analogous manner as having from x to y carbon atoms and being either unsubstituted or substituted with one or more R^{S}. Examples of unsubstituted (C₃-C₄₀)cycloalkyl are unsubstituted (C₃-C₂₀)cycloalkyl, unsubstituted (C₃-C₁₀)cycloalkyl, cyclopropyl, cyclobutyl, cyclopentyl, cyclohexyl, cycloheptyl, cyclooctyl, cyclononyl, and cyclodecyl. Examples of substituted (C₃-C₄₀)cycloalkyl are substituted (C₃-C₂₀)cycloalkyl, substituted (C₃-C₁₀)cycloalkyl, cyclopentanon-2-yl, and 1-fluorocyclohexyl.

Examples of (C₁-C₄₀)hydrocarbylene include unsubstituted or substituted (C₆-C₄₀)arylene, (C₃-C₄₀)cycloalkylene, and (C₁-C₄₀)alkylene (e.g., (C₁-C₂₀)alkylene). In some embodiments, the diradicals are on the same carbon atom (e.g., —CH₂—) or on adjacent carbon atoms (i.e., 1,2-diradicals), or are spaced apart by one, two, or more than two intervening carbon atoms (e.g., respective 1,3-diradicals, 1,4-diradicals, etc.). Some diradicals include α,ω-diradical. The α,ω-diradical is a diradical that has maximum carbon backbone spacing between the radical carbons. Some examples of (C₂-C₂₀)alkylene α,ω-diradicals include ethan-1,2-diyl (i.e. —CH₂CH₂—), propan-1,3-diyl (i.e. —CH₂CH₂CH₂—), 2-methylpropan-1,3-diyl (i.e. —CH₂CH(CH₃)CH₂—). Some examples of (C₆-C₅₀)arylene α,ω-diradicals include phenyl-1,4-diyl, napthalen-2,6-diyl, or napthalen-3,7-diyl.

The term “(C₁-C₄₀)alkylene” means a saturated straight chain or branched chain diradical (i.e., the radicals are not on ring atoms) of from 1 to 40 carbon atoms that is unsubstituted or substituted by one or more R^{S}. Examples of unsubstituted (C₁-C₅₀)alkylene are unsubstituted (C₁-C₂₀)alkylene, including unsubstituted —CH₂CH₂—, —(CH₂)₃—, —(CH₂)₄—, —(CH₂)₅—, —(CH₂)₆—, —(CH₂)₇—, —(CH₂)₈—, —CH₂C*HCH₃, and —(CH₂)₄C*(H)(CH₃), in which “C*” denotes a carbon atom from which a hydrogen atom is removed to form a secondary or tertiary alkyl radical. Examples of substituted (C₁-C₅₀)alkylene are substituted (C₁-C₂₀)alkylene, —CF₂—, —C(O)—, and —(CH₂)₁₄C(CH₃)₂(CH₂)₅— (i.e., a 6,6-dimethyl substituted normal-1,20-eicosylene). Since as mentioned previously two R^{S} may be taken together to form a (C₁-Cis)alkylene, examples of substituted (C₁-C₅₀)alkylene also include 1,2-bis(methylene)cyclopentane, 1,2-bis(methylene)cyclohexane, 2,3-bis(methylene)-7,7-dimethyl-bicyclo[2.2.1]heptane, and 2,3-bis(methylene)bicyclo[2.2.2]octane.

The term “(C₃-C₄₀)cycloalkylene” means a cyclic diradical (i.e., the radicals are on ring atoms) of from 3 to 40 carbon atoms that is unsubstituted or substituted by one or more R^{S}.

The term “heteroatom,” refers to an atom other than hydrogen or carbon. Examples of heteroatoms include O, S, S(O), S(O)₂, Si(R^{C})₂, P(R), N(R^{N}), —N═C(R^{C})₂, —Ge(R^{C})₂—, or —Si(R^{C}) —, where each R^{C}, each R^{N}, and each R^{P} is unsubstituted (C₁-C₁₈)hydrocarbyl or —H. The term “heterohydrocarbon” refers to a molecule or molecular framework in which one or more carbon atoms are replaced with a heteroatom. The term “(C₁-C₄₀)heterohydrocarbyl” means a heterohydrocarbon radical of from 1 to 40 carbon atoms and the term “(C₁-C₄₀)heterohydrocarbylene” means a heterohydrocarbon diradical of from 1 to 40 carbon atoms, and each heterohydrocarbon has one or more heteroatoms. The radical of the heterohydrocarbyl is on a carbon atom or a heteroatom, and diradicals of the heterohydrocarbyl may be on: (1) one or two carbon atom, (2) one or two heteroatoms, or (3) a carbon atom and a heteroatom. Each (C₁-C₅₀)heterohydrocarbyl and (C₁-C₅₀)heterohydrocarbylene may be unsubstituted or substituted (by one or more R^{S}), aromatic or non-aromatic, saturated or unsaturated, straight chain or branched chain, cyclic (including mono- and poly-cyclic, fused and non-fused polycyclic), or acyclic.

The (C₁-C₄₀)heterohydrocarbyl may be unsubstituted or substituted (C₁-C₄₀)heteroalkyl, (C₁-C₄₀)hydrocarbyl-O—, (C₁-C₄₀)hydrocarbyl-S—, (C₁-C₄₀)hydrocarbyl-S(O)—, (C₁-C₄₀)hydrocarbyl-S(O)₂—, (C₁-C₄₀)hydrocarbyl-Si(R^{C})₂—, (C₁-C₄₀)hydrocarbyl-N(R^{N})—, (C₁-C₄₀)hydrocarbyl-P(R)—, (C₂-C₄₀)heterocycloalkyl, (C₂-C₁₉)heterocycloalkyl-(C₁-C₂₀)alkylene, (C₃-C₂₀)cycloalkyl-(C₁-C₁₉)heteroalkylene, (C₂-C₁₉)heterocycloalkyl-(C₁-C₂₀)heteroalkylene, (C₁-C₄₀)heteroaryl, (C₁-C₁₉)heteroaryl-(C₁-C₂₀)alkylene, (C₆-C₂₀)aryl-(C₁-C₁₉)heteroalkylene, or (C₁-C₁₉)heteroaryl-(C₁-C₂₀)heteroalkylene.

The term “(C₄-C₄₀)heteroaryl” means an unsubstituted or substituted (by one or more R^{S}) mono-, bi- or tricyclic heteroaromatic hydrocarbon radical of from 4 to 40 total carbon atoms and from 1 to 10 heteroatoms, and the mono-, bi- or tricyclic radical comprises 1, 2 or 3 rings, respectively, wherein the 2 or 3 rings independently are fused or non-fused and at least one of the 2 or 3 rings is heteroaromatic. Other heteroaryl groups (e.g., (Cₓ-C_{y})heteroaryl generally, such as (C₄-C₁₂)heteroaryl) are defined in an analogous manner as having from x to y carbon atoms (such as 4 to 12 carbon atoms) and being unsubstituted or substituted by one or more than one R^{S}. The monocyclic heteroaromatic hydrocarbon radical is a 5-membered or 6-membered ring. The 5-membered ring has 5 minus h carbon atoms, wherein h is the number of heteroatoms and may be 1, 2, or 3; and each heteroatom may be O, S, N, or P. Examples of 5-membered ring heteroaromatic hydrocarbon radical are pyrrol-1-yl; pyrrol-2-yl; furan-3-yl; thiophen-2-yl; pyrazol-1-yl; isoxazol-2-yl; isothiazol-5-yl; imidazol-2-yl; oxazol-4-yl; thiazol-2-yl; 1,2,4-triazol-1-yl; 1,3,4-oxadiazol-2-yl; 1,3,4-thiadiazol-2-yl; tetrazol-1-yl; tetrazol-2-yl; and tetrazol-5-yl. The 6-membered ring has 6 minus h carbon atoms, wherein h is the number of heteroatoms and may be 1 or 2 and the heteroatoms may be N or P. Examples of 6-membered ring heteroaromatic hydrocarbon radical are pyridine-2-yl; pyrimidin-2-yl; and pyrazin-2-yl. The bicyclic heteroaromatic hydrocarbon radical can be a fused 5,6- or 6,6-ring system. Examples of the fused 5,6-ring system bicyclic heteroaromatic hydrocarbon radical are indol-1-yl; and benzimidazole-1-yl. Examples of the fused 6,6-ring system bicyclic heteroaromatic hydrocarbon radical are quinolin-2-yl; and isoquinolin-1-yl. The tricyclic heteroaromatic hydrocarbon radical can be a fused 5,6,5-; 5,6,6-; 6,5,6-; or 6,6,6-ring system. An example of the fused 5,6,5-ring system is 1,7-dihydropyrrolo[3,2-f]indol-1-yl. An example of the fused 5,6,6-ring system is 1H-benzo[f] indol-1-yl. An example of the fused 6,5,6-ring system is 9H-carbazol-9-yl. An example of the fused 6,5,6-ring system is 9H-carbazol-9-yl. An example of the fused 6,6,6-ring system is acrydin-9-yl.

The aforementioned heteroalkyl may be saturated straight or branched chain radicals containing (C₁-C₅₀) carbon atoms, or fewer carbon atoms and one or more of the heteroatoms. Likewise, the heteroalkylene may be saturated straight or branched chain diradicals containing from 1 to 50 carbon atoms and one or more than one heteroatoms. The heteroatoms, as defined above, may include Si(R^{C})₃, Ge(R^{C})₃, Si(R^{C})₂, Ge(R^{C})₂, P(R^{P})₂, P(R), N(R^{N})₂, N(R^{N}), N, O, OR^{C}, S, SR^{C}, S(O), and S(O)₂, wherein each of the heteroalkyl and heteroalkylene groups are unsubstituted or substituted by one or more R^{S}.

Examples of unsubstituted (C₂-C₄₀)heterocycloalkyl are unsubstituted (C₂-C₂₀)heterocycloalkyl, unsubstituted (C₂-C₁₀)heterocycloalkyl, aziridin-1-yl, oxetan-2-yl, tetrahydrofuran-3-yl, pyrrolidin-1-yl, tetrahydrothiophen-S,S-dioxide-2-yl, morpholin-4-yl, 1,4-dioxan-2-yl, hexahydroazepin-4-yl, 3-oxa-cyclooctyl, 5-thio-cyclononyl, and 2-aza-cyclodecyl.

The term “halogen atom” or “halogen” means the radical of a fluorine atom (F), chlorine atom (Cl), bromine atom (Br), or iodine atom (I). The term “halide” means anionic form of the halogen atom: fluoride (F⁻), chloride (Cl⁻), bromide (Br⁻), or iodide (I⁻).

The term “saturated” means lacking carbon-carbon double bonds, carbon-carbon triple bonds, and (in heteroatom-containing groups) carbon-nitrogen, carbon-phosphorous, and carbon-silicon double bonds. Where a saturated chemical group is substituted by one or more substituents R^{S}, one or more double and/or triple bonds optionally may or may not be present in substituents R^{S}. The term “unsaturated” means containing one or more carbon-carbon double bonds, carbon-carbon triple bonds, and (in heteroatom-containing groups) carbon-nitrogen, carbon-phosphorous, and carbon-silicon double bonds, not including any such double bonds that may be present in substituents R^{S}, if any, or in (hetero) aromatic rings, if any.

According to some embodiments, a catalyst system for producing a the multimodal ethylene-based copolymer composition includes a metal-ligand complex according to formula (I):

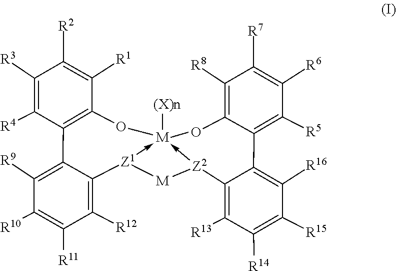

In formula (I), M is a metal chosen from titanium, zirconium, or hafnium, the metal being in a formal oxidation state of +2, +3, or +4; n is 0, 1, or 2; when n is 1, X is a monodentate ligand or a bidentate ligand; when n is 2, each X is a monodentate ligand and is the same or different; the metal-ligand complex is overall charge-neutral; each Z is independently chosen from —O—, —S—, —N(R^{N})—, or —P(R^{P})—; L is (C₁-C₄₀)hydrocarbylene or (C₁-C₄₀)heterohydrocarbylene, wherein the (C₁-C₄₀)hydrocarbylene has a portion that comprises a 1-carbon atom to 10-carbon atom linker backbone linking the two Z groups in Formula (I) (to which L is bonded) or the (C₁-C₄₀)heterohydrocarbylene has a portion that comprises a 1-atom to 10-atom linker backbone linking the two Z groups in Formula (I), wherein each of the 1 to 10 atoms of the 1-atom to 10-atom linker backbone of the (C₁-C₄₀)heterohydrocarbylene independently is a carbon atom or heteroatom, wherein each heteroatom independently is O, S, S(O), S(O)₂, Si(R^{C})₂, Ge(R^{C})₂, P(R^{C}), or N(R^{C}), wherein independently each R^{C} is (C₁-C₃₀)hydrocarbyl or (C₁-C₃₀)heterohydrocarbyl; R¹ and R⁸ are independently selected from the group consisting of —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{N})₂NC(O)—, halogen, and radicals having formula (II), formula (III), or formula (IV):

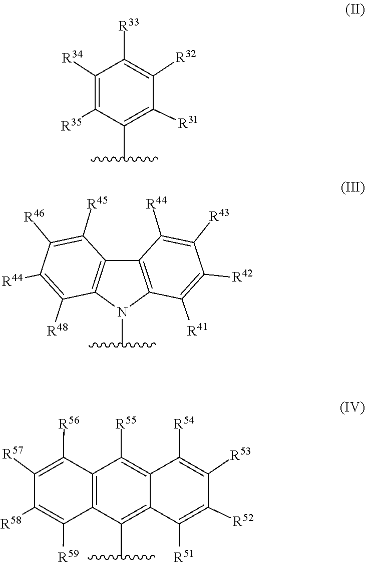

In formulas (II), (III), and (IV), each of R³¹⁻³⁵, R⁴¹⁻⁴⁸, or R⁵¹⁻⁵⁹ is independently chosen from (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —N═CHR^{C}, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{N})₂NC(O)—, halogen, or —H, provided at least one of R¹ or R⁸ is a radical having formula (II), formula (III), or formula (IV).

In formula (I), each of R²⁻⁴, R⁵⁻⁷, and R⁹⁻¹⁶ is independently selected from (C₁-C₄₀)hydrocarbyl, (C₁-C₄₀)heterohydrocarbyl, —Si(R^{C})₃, —Ge(R^{C})₃, —P(R^{P})₂, —N(R^{N})₂, N═CHR^{C}, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{C})₂NC(O)—, halogen, and —H.

In some embodiments, the multimodal ethylene-based copolymer composition is formed using a first catalyst according to formula (I) in a first reactor and a different catalyst according to formula (I) in a second reactor.

### Co-Catalyst Component

The catalyst system comprising a metal-ligand complex of formula (I) may be rendered catalytically active by any technique known in the art for activating metal-based catalysts of olefin polymerization reactions. For example, the system comprising a metal-ligand complex of formula (I) may be rendered catalytically active by contacting the complex to, or combining the complex with, an activating co-catalyst. Suitable activating co-catalysts for use herein include alkyl aluminums; polymeric or oligomeric alumoxanes (also known as aluminoxanes); neutral Lewis acids; and non-polymeric, non-coordinating, ion-forming compounds (including the use of such compounds under oxidizing conditions). A suitable activating technique is bulk electrolysis. Combinations of one or more of the foregoing activating co-catalysts and techniques are also contemplated. The term “alkyl aluminum” means a monoalkyl aluminum dihydride or monoalkylaluminum dihalide, a dialkyl aluminum hydride or dialkyl aluminum halide, or a trialkylaluminum. Examples of polymeric or oligomeric alumoxanes include methylalumoxane, triisobutylaluminum-modified methylalumoxane, and isobutylalumoxane.

Lewis acid activators (co-catalysts) include Group 13 metal compounds containing from 1 to 3 (C₁-C₂₀)hydrocarbyl substituents as described herein. In one embodiment, Group 13 metal compounds are tri((C₁-C₂₀)hydrocarbyl)-substituted-aluminum or tri((C₁-C₂₀)hydrocarbyl)-boron compounds. In embodiments, Group 13 metal compounds are tri(hydrocarbyl)-substituted-aluminum, tri((C₁-C₂₀)hydrocarbyl)-boron compounds, tri((C₁-C₁₀)alkyl)aluminum, tri((C₆-C₁₅)aryl)boron compounds, and halogenated (including perhalogenated) derivatives thereof. In further embodiments, Group 13 metal compounds are tris(fluoro-substituted phenyl)boranes, tris(pentafluorophenyl)borane. In some embodiments, the activating co-catalyst is a tris((C₁-C₂₀)hydrocarbyl borate (e.g. trityl tetrafluoroborate) or a tri((C₁-C₂₀)hydrocarbyl)ammonium tetra((C₁-C₂₀)hydrocarbyl)borane (e.g. bis(octadecyl)methylammonium tetrakis(pentafluorophenyl)borane). As used herein, the term “ammonium” means a nitrogen cation that is a ((C₁-C₂₀)hydrocarbyl)₄N⁺ a ((C₁-C₂₀)hydrocarbyl)₃N(H)⁺, a ((C₁-C₂₀)hydrocarbyl)₂N(H)₂⁺, (C₁-C₂₀)hydrocarbylN(H)₃⁺, or N(H)₄⁺, wherein each (C₁-C₂₀)hydrocarbyl, when two or more are present, may be the same or different.

Combinations of neutral Lewis acid activators (co-catalysts) include mixtures comprising a combination of a tri((C₁-C₄)alkyl)aluminum and a halogenated tri((C₆—Cis)aryl)boron compound, especially a tris(pentafluorophenyl)borane. Embodiments are combinations of such neutral Lewis acid mixtures with a polymeric or oligomeric alumoxane, and combinations of a single neutral Lewis acid, especially tris(pentafluorophenyl)borane with a polymeric or oligomeric alumoxane. Ratios of numbers of moles of (metal-ligand complex):(tris(pentafluoro-phenylborane):(alumoxane) [e.g., (Group 4 metal-ligand complex):(tris(pentafluoro-phenylborane):(alumoxane)] are from 1:1:1 to 1:10:30, in embodiments, from 1:1:1.5 to 1:5:10

The catalyst system comprising the metal-ligand complex of formula (I) may be activated to form an active catalyst composition by combination with one or more co-catalysts, for example, a cation forming co-catalyst, a strong Lewis acid, or combinations thereof. Suitable activating co-catalysts include polymeric or oligomeric aluminoxanes, especially methyl aluminoxane, as well as inert, compatible, noncoordinating, ion forming compounds. Exemplary suitable co-catalysts include, but are not limited to: modified methyl aluminoxane (MMAO), bis(hydrogenated tallow alkyl)methyl, tetrakis(pentafluorophenyl)borate(1⁻) amine, and combinations thereof.

In some embodiments, one or more of the foregoing activating co-catalysts are used in combination with each other. An especially preferred combination is a mixture of a tri((C₁-C₄)hydrocarbyl)aluminum, tri((C₁-C₄)hydrocarbyl)borane, or an ammonium borate with an oligomeric or polymeric alumoxane compound. The ratio of total number of moles of one or more metal-ligand complexes of formula (I) to total number of moles of one or more of the activating co-catalysts is from 1:10,000 to 100:1. In some embodiments, the ratio is at least 1:5000, in some embodiments, at least 1:1000; and 10:1 or less, and in some embodiments, 1:1 or less. When an alumoxane alone is used as the activating co-catalyst, preferably the number of moles of the alumoxane that are employed is at least 100 times the number of moles of the metal-ligand complex of formula (I). When tris(pentafluorophenyl)borane alone is used as the activating co-catalyst, in some embodiments, the number of moles of the tris(pentafluorophenyl)borane that are employed to the total number of moles of one or more metal-ligand complexes of formula (I) from 0.5:1 to 10:1, from 1:1 to 6:1, or from 1:1 to 5:1. The remaining activating co-catalysts are generally employed in approximately mole quantities equal to the total mole quantities of one or more metal-ligand complexes of formula (I).

### Compositions

It was discovered that by performing processes as described above, multimodal ethylene-based copolymer compositions with improved melt strength can be produced. Properties of the multimodal ethylene-based copolymer composition according to embodiments disclosed and described herein will now be provided. It should be understood that by modifying the various process conditions described above embodiments of the multimodal ethylene-based copolymer composition with differing and desirable properties can be produced. Although the properties listed below are recited in separate paragraphs, it should be understood that any property from any paragraph below may be combined with any other property from any paragraph below by modifying the various process conditions discussed above. Therefore, the multimodal ethylene-based copolymer composition having any combination of various properties listed below are envisioned and can be produced, according to embodiments.

In one or more embodiments, the multimodal ethylene-based copolymer composition may have a density of 0.900 g/cm³ to 0.940 g/cm³. For example, embodiments of the presently-disclosed multimodal ethylene-based copolymer composition may have densities of from 0.900 g/cm³ to 0.925 g/cm³, from 0.900 g/cm³ to 0.920 g/cm³, from 0.900 g/cm³ to 0.918 g/cm³, from 0.900 g/cm³ to 0.916 g/cm³, from 0.900 g/cm³ to 0.914 g/cm³, from 0.900 g/cm³ to 0.912 g/cm³, from 0.900 g/cm³ to 0.910 g/cm³, from 0.900 g/cm³ to 0.908 g/cm³, from 0.900 g/cm³ to 0.906 g/cm³, from 0.900 g/cm³ to 0.904 g/cm³, from 0.900 g/cm³ to 0.902 g/cm³, from 0.902 g/cm³ to 0.920 g/cm³, from 0.902 g/cm³ to 0.918 g/cm³, from 0.902 g/cm³ to 0.916 g/cm³, from 0.902 g/cm³ to 0.914 g/cm³, from 0.902 g/cm³ to 0.912 g/cm³, from 0.902 g/cm³ to 0.910 g/cm³, from 0.902 g/cm³ to 0.908 g/cm³, from 0.902 g/cm³ to 0.906 g/cm³, from 0.902 g/cm³ to 0.904 g/cm³, from 0.904 g/cm³ to 0.920 g/cm³, from 0.904 g/cm³ to 0.918 g/cm³, from 0.904 g/cm³ to 0.916 g/cm³, from 0.904 g/cm³ to 0.914 g/cm³, from 0.904 g/cm³ to 0.912 g/cm³, from 0.904 g/cm³ to 0.910 g/cm³, from 0.904 g/cm³ to 0.908 g/cm³, from 0.904 g/cm³ to 0.906 g/cm³, from 0.906 g/cm³ to 0.920 g/cm³, from 0.906 g/cm³ to 0.918 g/cm³, from 0.906 g/cm³ to 0.916 g/cm³, from 0.906 g/cm³ to 0.914 g/cm³, from 0.906 g/cm³ to 0.912 g/cm³, from 0.906 g/cm³ to 0.910 g/cm³, from 0.906 g/cm³ to 0.908 g/cm³, from 0.908 g/cm³ to 0.920 g/cm³, from 0.908 g/cm³ to 0.918 g/cm³, from 0.908 g/cm³ to 0.916 g/cm³, from 0.908 g/cm³ to 0.914 g/cm³, from 0.908 g/cm³ to 0.912 g/cm³, from 0.908 g/cm³ to 0.910 g/cm³, from 0.910 g/cm³ to 0.920 g/cm³, from 0.910 g/cm³ to 0.918 g/cm³, from 0.910 g/cm³ to 0.916 g/cm³, from 0.910 g/cm³ to 0.914 g/cm³, from 0.910 g/cm³ to 0.912 g/cm³, from 0.912 g/cm³ to 0.920 g/cm³, from 0.912 g/cm³ to 0.918 g/cm³, from 0.912 g/cm³ to 0.916 g/cm³, from 0.912 g/cm³ to 0.914 g/cm³, from 0.914 g/cm³ to 0.920 g/cm³, from 0.914 g/cm³ to 0.918 g/cm³, from 0.914 g/cm³ to 0.916 g/cm³, from 0.916 g/cm³ to 0.920 g/cm³, from 0.916 g/cm³ to 0.918 g/cm³, from 0.918 g/cm³ to 0.920 g/cm³, or any combination of these ranges.

In one or more embodiments, the multimodal ethylene-based copolymer composition may have a melt index (I₂) of from 0.50 g/10 minutes (g/10 min) to 10.0 g/10 min when measured according to ASTM D-1238 at 190° C. and 2.16 kg. In one or more embodiments, the multimodal ethylene-based copolymer composition may have a melt index (I₂) of from 0.5 g/10 min to 10.0 g/10 min, from 0.5 g/10 min to 9.0 g/10 min, from 0.5 g/10 min to 8.0 g/10 min, from 0.5 g/10 min to 7.0 g/10 min, from 0.5 g/10 min to 6.0 g/10 min, from 0.5 g/10 min to 5.0 g/10 min, from 0.5 g/10 min to 4.0 g/10 min, from 0.5 g/10 min to 3.0 g/10 min, from 0.5 g/10 min to 2.0 g/10 min, from 0.5 g/10 min to 1.0 g/10 min, from 1.0 g/10 min to 10.0 g/10 min, from 1.0 g/10 min to 9.0 g/10 min, from 1.0 g/10 min to 8.0 g/10 min, from 1.0 g/10 min to 7.0 g/10 min, from 1.0 g/10 min to 6.0 g/10 min, from 1.0 g/10 min to 5.0 g/10 min, from 1.0 g/10 min to 4.0 g/10 min, from 1.0 g/10 min to 3.0 g/10 min, from 1.0 g/10 min to 2.0 g/10 min, from 2.0 g/10 min to 10.0 g/10 min, from 2.0 g/10 min to 9.0 g/10 min, from 2.0 g/10 min to 8.0 g/10 min, from 2.0 g/10 min to 7.0 g/10 min, from 2.0 g/10 min to 6.0 g/10 min, from 2.0 g/10 min to 5.0 g/10 min, from 2.0 g/10 min to 4.0 g/10 min, from 2.0 g/10 min to 3.0 g/10 min, from 3.0 g/10 min to 10.0 g/10 min, from 3.0 g/10 min to 9.0 g/10 min, from 3.0 g/10 min to 8.0 g/10 min, from 3.0 g/10 min to 7.0 g/10 min, from 3.0 g/10 min to 6.0 g/10 min, from 3.0 g/10 min to 5.0 g/10 min, from 3.0 g/10 min to 4.0 g/10 min, from 4.0 g/10 min to 10.0 g/10 min, from 4.0 g/10 min to 9.0 g/10 min, from 4.0 g/10 min to 8.0 g/10 min, from 4.0 g/10 min to 7.0 g/10 min, from 4.0 g/10 min to 6.0 g/10 min, from 4.0 g/10 min to 5.0 g/10 min, from 5.0 g/10 min to 10.0 g/10 min, from 5.0 g/10 min to 9.0 g/10 min, from 5.0 g/10 min to 8.0 g/10 min, from 5.0 g/10 min to 7.0 g/10 min, from 5.0 g/10 min to 6.0 g/10 min, from 6.0 g/10 min to 10.0 g/10 min, from 6.0 g/10 min to 9.0 g/10 min, from 6.0 g/10 min to 8.0 g/10 min, from 6.0 g/10 min to 7.0 g/10 min, from 7.0 g/10 min to 10.0 g/10 min, from 7.0 g/10 min to 9.0 g/10 min, from 7.0 g/10 min to 8.0 g/10 min, from 8.0 g/10 min to 10.0 g/10 min, from 8.0 g/10 min to 9.0 g/10 min, from 9.0 g/10 min to 10.0 g/10 min, or any combination of these ranges, when measured according to ASTM D-1238 at 190° C. and 2.16 kg.

According to embodiments, the multimodal ethylene-based copolymer composition may have a molecular weight distribution, expressed as the ratio of the weight average molecular weight to number average molecular weight (Mw/Mn), in the range of from 2.0 to 6.0. For example, the multimodal ethylene-based copolymer composition may have a molecular weight distribution of from 2.0 to 5.5, 2.0 to 5.0, 2.0 to 4.5, 2.0 to 4.0, 2.0 to 3.5, 2.0 to 3.0, 2.0 to 2.5, 2.5 to 6.0, 3.0 to 5.5, 3.0 to 5.0, 3.0 to 4.5, 3.0 to 4.0, 3.0 to 3.5, 3.5 to 6.0, 3.5 to 5.5, 3.5 to 5.0, 3.5 to 4.5, 3.5 to 4.0, 4.0 to 6.0, 4.0 to 5.5, 4.0 to 5.0, 4.0 to 4.5, 4.5 to 6.0, 4.5 to 5.5, 4.5 to 5.0, 5.0 to 6.0, 5.0 to 5.5, or 5.5 to 6.0, or any combination of these ranges. As presently described, the molecular weight distribution may be calculated according to gel permeation chromatography (GPC) techniques as described herein.

The long chain branching frequency (LCB_{f}) refers to the level of long chain branches per 1000 carbons. In embodiments, the long chain branching frequency (LCB_{f}) of the multimodal ethylene-based copolymer composition is greater than or equal to 0.3 and less than or equal to 1.0. In one or more embodiments, the long chain branching frequency (LCB_{f}) of the multimodal ethylene-based copolymer composition may be from 0.3 to 1.0, from 0.3 to 0.8, from 0.3 to 0.7, from 0.3 to 0.6, from 0.5 to 1.0, from 0.5 to 0.9, from 0.5 to 0.8, from 0.8 to 1.0 or any combination of these ranges.

According to embodiments, the multimodal ethylene-based copolymer composition may have an activation energy (Ea) of the composition as determined from dynamic mechanical analysis may be greater than 30 kJ/mol. The activation energy is calculated from rheology time-temperature superposition viscosity data obtained from melt rheology frequency sweeps. These measurements were performed using TA Instruments Advanced Rheometric Expansion System (ARES) equipped with 25 mm parallel plates using nitrogen pure. Linear viscoelastic response was measured at three different temperatures 150° C., 190° C., and 230° C., using frequencies of 0.1-500 rad/s., 0.1-100 rad/s, and 0.01-100 rad/s, respectively. Strain was altered based on transducer torque output, making sure torque remained with acceptable range. The stress response was analyzed in terms of amplitude and phase, from which the storage and loss moduli and dynamic melt viscosity were calculated. The temperature dependence of linear viscoelastic curve can be predicted by shifting the modulus curves across the frequency axis (X-axis) against a reference using sets of shift factors. This concept is generally known as time-temperature superposition. This technique involves shifting curves at different temperatures in such a way that they overlap and form a single curve, also known as the master curve. The shift factors were generated using RepTate software. Reference temperature was chosen at 190° C. The Arrhenius equation associates the horizontal shift factors to the activation energy and a reference temperature according to the following equation:

$${a}_{T} = {e}^{\frac{Ea}{R} ( \frac{1}{T} - \frac{1}{{T}_{ref}} )} \qquad ( EQ . 1 )$$

In further embodiments, the multimodal ethylene-based copolymer compositions may have an activation energy (Ea) of the composition as determined from dynamic mechanical analysis may be from 30 kJ/mol to 60 kJ/mol, from 30 kJ/mol to 50 kJ/mol, from 30 kJ/mol to 40 kJ/mol, from 40 kJ/mol to 60 kJ/mol, from 40 kJ/mol to 50 kJ/mol, or from 50 kJ/mol to 60 kJ/mol.

According to embodiments, the multimodal ethylene-based copolymer composition may have a melt strength (MS) that satisfies the following equation 1:

$$M S = \frac{x}{{I}_{2}} + y \qquad ( EQ . 2 )$$

wherein x is greater than or equal to 8, y is greater than or equal to 3, and I₂ is a melt index of the copolymer measured according to ASTM 1238 at 2.16 kg and 190° C. According to one or more embodiments, the multimodal ethylene-based copolymer composition may have a melt strength of at least 5 centiNewtons (cN). In further embodiments, the multimodal ethylene-based copolymer composition may have a melt strength of from 5 cN to 50 cN, from 5 cN to 45 cN, from 5 cN to 40 cN, from 5 cN to 35 cN, from 5 cN to 30 cN, from 5 cN to 25 cN, from 5 cN to 20 cN, from 5 cN to 15 cN, from 5 cN to 10 cN, from 10 cN to 50 cN, from 10 cN to 45 cN, from 10 cN to 40 cN, from 10 cN to 35 cN, from 10 cN to 30 cN, from 10 cN to 25 cN, from 10 cN to 20 cN, from 10 cN to 15 cN, from 15 cN to 50 cN, from 15 cN to 45 cN, from 15 cN to 40 cN, from 15 cN to 35 cN, from 15 cN to 30 cN, from 15 cN to 25 cN, from 15 cN to 20 cN, from 20 cN to 50 cN, from 20 cN to 45 cN, from 20 cN to 40 cN, from 20 cN to 35 cN, from 20 cN to 30 cN, from 20 cN to 25 cN, from 25 cN to 50 cN, from 25 cN to 45 cN, from 25 cN to 40 cN, from 25 cN to 35 cN, from 25 cN to 30 cN, from 30 cN to 50 cN, from 30 cN to 45 cN, from 30 cN to 40 cN, from 30 cN to 35 cN, from 35 cN to 50 cN, from 35 cN to 45 cN, from 35 cN to 40 cN, from 40 cN to 50 cN, from 40 cN to 45 cN, or from 45 cN to 50 cN.

In embodiments, the multimodal ethylene-based copolymer composition may have a ratio of viscosity measured at 0.1 radians/second and 190° C. to viscosity measured at 100 radians/second and 190° C. (V0.1/V100), as determined by dynamic mechanical analysis, of greater than 5. In further embodiments, the multimodal ethylene-based copolymer composition may have a (V0.1/V100), as determined by dynamic mechanical analysis, of from 5 to 30, from 5 to 25, from 5 to 20, from 5 to 15, from 5 to 10, from 10 to 30, from 10 to 25, from 10 to 20, from 10 to 15, from 15 to 30, from 15 to 25, from 15 to 20, from 20 to 30, from 20 to 25, or from 25 to 30.

In embodiments, the cumulative distribution fractions (CDF) for light scattering analysis (CDF_{LS}) at a molecular weight greater than 500,000 g/mol is greater than or equal to 8%,

In embodiments, the multimodal ethylene-based copolymer composition may have a high molecular weight fraction, computed by measuring an area fraction of a low angle light scattering (LALLS) detector chromatogram greater than 500,000 g/mol using GPC molecular weight distribution, of from 8% to 50%. In embodiments, the high molecular weight fraction, computed by measuring an area fraction of a low angle light scattering (LALLS) detector chromatogram greater than 500,000 g/mol using GPC molecular weight distribution, may be from 8% to 40%, from 8% to 30%, from 8% to 20% from 8% to 10%, from 10% to 50%, from 10% to 40%, from 10% to 30%, from 10% to 20%, from 20% to 50%, from 20% to 40%, from 20% to 30%, from 30% to 50%, from 30% to 40%, or from 40% to 50%. In embodiments, the multimodal ethylene-based copolymer composition may have a low molecular weight fraction, computed by measuring an area fraction of a low angle light scattering (LALLS) detector chromatogram less than 500,000 g/mol using GPC molecular weight distribution, of greater than 50%. In embodiments, the low molecular weight fraction, computed by measuring an area fraction of a low angle light scattering (LALLS) detector chromatogram less than 500,000 g/mol using GPC molecular weight distribution, may be from 50% to 92%, from 50% to 90%, from 50% to 80% from 50% to 70%, from 50% to 60%, from 60% to 92%, from 60% to 90%, from 60% to 80%, from 60% to 70%, from 70% to 92%, from 70% to 90%, from 70% to 80%, from 80% to 92%, from 80% to 90%, or from 90% to 92%. Traditionally, it was thought that having as much high molecular weight material as possible was ideal because high molecular weight would lead to higher levels of entanglements that improve the properties of the LLDPE. Accordingly, low molecular weight material was kept to a minimum. However, the multimodal ethylene-based copolymer compositions according to embodiments disclosed and described herein exhibit unique and unexpected characteristics compared to commercially available LDPE products when the high molecular weight fraction, computed by measuring an area fraction of a low angle light scattering (LALLS) detector chromatogram greater than 500,000 g/mol using GPC molecular weight distribution, is from 8% to 50%.

In embodiments, the amount of long-chain branching derived from the concentration of vinyl groups in the multimodal ethylene-based copolymer composition produced expressed in vinyls/1,000 carbon atoms may be from 0.475 to 0.600. The amount of long-chain branching derived from the concentration of vinyl groups in the multimodal ethylene-based copolymer composition may be described according to the test methods described subsequently herein. In embodiments, the amount of long-chain branching derived from the concentration of vinyl groups in the multimodal ethylene-based copolymer composition produced expressed in vinyls/1,000 carbon atoms may be from 0.475 to 0.575, from 0.475 to 0.550, from 0.475 to 0.525, from 0.475 to 0.500, from 0.500 to 0.600, from 0.500 to 0.575, from 0.500 to 0.550, from 0.500 to 0.525, from 0.525 to 0.600, from 0.525 to 0.575, from 0.525 to 0.550, from 0.550 to 0.600, from 0.550 to 0.575, or from 0.575 to 0.600. Without being bound by theory, the vinyl end groups may enable the formation of long chain branching, which is a contributing factor to the melt strengths achieved in the multimodal ethylene-based copolymer compositions described herein.

The multimodal ethylene-based copolymer compositions may further comprise one or more additives. Such additives include, but are not limited to, antistatic agents, color enhancers, dyes, lubricants, pigments, primary antioxidants, secondary antioxidants, processing aids, UV stabilizers, and combinations thereof. The multimodal ethylene-based copolymer compositions may contain any amounts of additives. The multimodal ethylene-based copolymer compositions may compromise from about 0 to about 10 percent by the combined weight of such additives, based on the total weight of the multimodal ethylene-based copolymer compositions. The multimodal ethylene-based copolymer compositions may further comprise fillers, which may include, but are not limited to, organic or inorganic fillers. The multimodal ethylene-based copolymer compositions may contain from about 0 to about 20 weight percent fillers such as, for example, calcium carbonate, talc, or Mg(OH)₂, based on the total weight of the multimodal ethylene-based copolymer compositions. The multimodal ethylene-based copolymer compositions may further be blended with one or more polymers to form a blend.

### TEST METHODS

Unless otherwise indicated herein, the following analytical methods are used in describing aspects of the present disclosure:

### Melt Index

Melt indices I₂ (or I2) and I₁₀ (or I10) of polymer samples were measured in accordance to ASTM D-1238 (method B) at 190° C. and at 2.16 kg and 10 kg load, respectively. Their values are reported in g/10 min.

### Density

Samples for density measurement were prepared according to ASTM D4703. Measurements were made, according to ASTM D792, Method B, within one hour of sample pressing.

### Triple Detector Gel Permeation Chromatigraphy (GPC)

The chromatographic system consisted of a PolymerChar GPC-IR (Valencia, Spain) high temperature GPC chromatograph equipped with an internal IR5 infra-red detector (IR5) and 4-capillary viscometer (DV) coupled to a Precision Detectors (Now Agilent Technologies) 2-angle laser light scattering (LS) detector Model 2040. For all absolute Light scattering measurements, the 15 degree angle is used for measurement. The autosampler oven compartment was set at 1600 Celsius and the column and detector compartment were set at 150° Celsius. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

The total plate count of the GPC column set was performed with decane which was introduced into blank sample via a micropump controlled with the PolymerChar GPC-IR system. The plate count for the chromatographic system should be greater than 18,000 for the 4 Agilent “Mixed A” 30 cm 20-micron linear mixed-bed columns.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 1600 Celsius under “low speed” shaking.

In order to monitor the deviations over time, a flowrate marker (decane) was introduced into each sample via a micropump controlled with the PolymerChar GPC-IR system. This flowrate marker (FM) was used to linearly correct the pump flowrate (Flowrate₍ₙₒₘᵢₙₐₗ₎) for each sample by RV alignment of the respective decane peak within the sample (RV_{(FM Sample)}) to that of the decane peak within the narrow standards calibration (RV_{(FM Calibrated)}). Any changes in the time of the decane marker peak are then assumed to be related to a linear-shift in flowrate (Flowrate_{(effective)}) for the entire run. After calibrating the system based on a flow marker peak, the effective flowrate (with respect to the narrow standards calibration) is calculated as Equation 1. Processing of the flow marker peak was done via the PolymerChar GPCOne™ Software. Acceptable flowrate correction is such that the effective flowrate should be within +/−0.5% of the nominal flowrate.

Flowrate_{(effective)}=Flowrate₍ₙₒₘᵢₙₐₗ₎*(RV_{(FM Calibrated)}/RV_{(FM Sample)}) (EQ. 3)

For the determination of the viscometer and light scattering detector offsets from the IR5 detector, the Systematic Approach for the determination of multi-detector offsets is done in a manner consistent with that published by Balke, Mourey, et. al. (Mourey and Balke, Chromatography Polym. Chpt 12, (1992)) (Balke, Thitiratsakul, Lew, Cheung, Mourey, Chromatography Polym. Chpt 13, (1992)), optimizing triple detector log (MW and IV) results from a linear homopolymer polyethylene standard (3.5>Mw/Mn>2.2) with a molecular weight in the range of 115,000 to 125,000 g/mol to the narrow standard column calibration results from the narrow standards calibration curve using PolymerChar GPCOne™ Software.

The absolute molecular weight data was obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, NY (1987)) using PolymerChar GPCOne™ software. The overall injected concentration, used in the determination of the molecular weight, was obtained from the mass detector area and the mass detector constant, derived from a suitable linear polyethylene homopolymer, or one of the polyethylene standards of known weight-average molecular weight. The calculated molecular weights (using GPCOne™) were obtained using a light scattering constant, derived from one or more of the polyethylene standards mentioned below, and a refractive index concentration coefficient, dn/dc, of −0.104. Generally, the mass detector response (IR5) and the light scattering constant (determined using GPCOne™) should be determined from a linear standard with a molecular weight in excess of about 50,000 g/mole. The viscometer calibration (determined using GPCOne™) can be accomplished using the methods described by the manufacturer, or, alternatively, by using the published values of suitable linear standards, such as Standard Reference Materials (SRM) 1475 (available from National Institute of Standards and Technology (NIST)). A viscometer constant (obtained using GPCOne™) is calculated which relates specific viscosity area (DV) and injected mass for the calibration standard to its intrinsic viscosity. The chromatographic concentrations are assumed low enough to eliminate addressing 2nd viral coefficient effects (concentration effects on molecular weight).

The absolute weight average molecular weight (MW_{(Abs)}) is obtained (using GPCOne™) from the Area of the Light Scattering (LS) integrated chromatogram (factored by the light scattering constant) divided by the mass recovered from the mass constant and the mass detector (IR5) area. The molecular weight and intrinsic viscosity responses are linearly extrapolated at chromatographic ends where signal to noise becomes low (using GPCOne™) Other respective moments, Mn_{(Abs)} and Mz_{(Abs)} are be calculated according to equations 8-10 as follows:

$${Mn}_{( Abs )} = \frac{{\sum }^{i} {IR}_{i}}{{\sum }^{i} ( {IR}_{i} / {M}_{{Absolute}_{i}} )} \qquad ( EQ . 4 )$$

$$Mw ( Abs ) = \frac{{\sum }^{i} {IR}_{i} \times {M}_{{Absolute}_{i}}}{{\sum }^{i} {IR}_{i}} \qquad ( EQ . 5 )$$

$${Mz}_{( Abs )} = \frac{{\sum }^{i} ( {IR}_{i} * {M}_{{Absolute}_{i}}^{2} )}{{\sum }^{i} ( {IR}_{i} * {M}_{{Absolute}_{i}} )} \qquad ( EQ . 6 )$$

### CDF Calculation Method

The calculation of the cumulative detector fractions (CDF) for the low angle laser light scattering detector (“CDF_{LS}”) are accomplished by the following steps:

1) Linearly flow correct the chromatogram based on decane flow marker injection as described above.

2) Perform detector offsets as described above.

3) Calculate absolute molecular weights from light scattering as described above.

4) Calculate the cumulative detector fraction (CDF) of the Low-Angle Laser Light Scattering (LALLS) chromatogram (CDF_{LS}) based on its baseline-subtracted peak height (H) from high to low molecular weight (low to high retention volume) at each data slice (j) according to Equation 14.

$$C D {F}_{LS \geq 500 , 000 MW} = \frac{{\sum }_{j = Rv at Lowest Inegrated Volume}^{j = RV at 500 , 000 MW} Hj}{{\sum }_{j = Rv at Lowest Inegrated Volume}^{j = Rv at Highest Inegrated Volume} Hj} \qquad ( EQ . 7 )$$

### Calculation of LCB Frequency (LCB_{f})

The long chain branching frequency was calculated based on the differences between the g′, which is a ratio of the intrinsic viscosity of a polymer sample over a linear polymer reference with the same molecular weight. In 3D GPC practice, a reference polyethylene homopolymer, containing no detectable LCB or SCB, and with a Mw of approximately 120,000 g/mol and polydispersity around 3.0, is injected at the beginning of each run queue to establish the Mark-Houwink linear reference line. A first-order linear fit is applied to the obtained log of the intrinsic viscosity and log of the molecular weight data within the log of the molecular weight range of 4.5 to 5.8 g/mol to provide the linear reference K and a values.

A polyethylene sample of interest is analyzed to obtain intrinsic viscosity, molecular weight values, and the value of gᵢ′ is calculated at each chromatographic slice (i) according to Equation 15:

$${g}_{i}^{′} = ( {IV}_{Sample , i} / {IV}_{linear reference , i} ) \qquad ( EQ . 8 )$$

where the calculation utilizes the IV_{Sample,i} at equivalent absolute molecular weight values and same SCB content values to the linear reference within the log molecular weight range of 4.5 to 5.8 g/mol. If a difference in SCB content exists, the IV_{linear referene,i} is vertically shifted by adjusting the K value from the Mark-Houwink Plot to account for the SCB correction compared to the IV_{Sample,i}. The shift is done until the linear reference line makes a single point of contact to make a tangent with the sample Mark-Houwink line at a log molecular weight of 4.5.

A Zimm-Stockmayer branching factor g was calculated from g′, g′=g^{ε}, using an epsilon factor of 0.5. The number of branches along the polymer sample (Bₙ) at each data slice (i) can be determined by using Equation 16, (B. H. Zimm and W. H. Stockmayer, J. Chem. Phys. 17, 1301 (1949)):

$$g = {[ {( 1 + \frac{{B}_{n , i}}{7} )}^{1 / 2} + \frac{4}{9} \frac{{B}_{n , i}}{π} ]}^{- 1 / 2} \qquad ( EQ . 9 )$$

Finally, the average LCBf quantity per 1000 carbons in the polymer across all of the slices (i) can be determined using Equation 17:

$$LCBf = \frac{{\sum }^{i} ( \frac{{B}_{n , i}}{{M}_{i} / 14000} {c}_{i} )}{\sum {c}_{i}} \qquad ( EQ . 10 )$$

### Procedure for NMR End Group Analysis Including Vinyl Count Determination

To determine vinyl count, approximately 7 mg of polymer sample was loaded into a 5 mm NMR tube with 0.6 ml tetrachloroethane-d₂ with 0.008 M chromium(III) acetylacetonate. The tube was purged with N₂, and the cap was secured with Teflon tape. The prepared sample tube was heated in a heating block set at 125° C. and repeatedly vortexed until a homogeneous solution was achieved evidenced by consistent flow when the tube was tipped horizontally. The finished sample was inserted into a Bruker AVANCE 600 MHz system equipped with a 10 mm high-temperature cryo-probe set at 120° C. The acquisition parameters for the ¹H NMR spectra are: 90 degree pulse, 1.8 second acquisition time, 10 seconds relaxation delay, center of spectrum set at 2 ppm, spectral width of 20 ppm and 128 scans for signal averaging. The resulting raw FID was exponential multiplied, Fourier transformed, phased, baseline corrected, and integrated using MNOVA software.

### Procedure for Polymerization in a Continuous Reactor: Setup 1

Raw materials (ethylene, 1-octene) and the process solvent (a narrow boiling range high-purity isoparaffinic solvent trademarked Isopar E commercially available from ExxonMobil Corporation) are purified with molecular sieves before introduction into the reaction environment. Hydrogen is supplied in pressurized cylinders as a high purity grade and is not further purified. The reactor monomer feed (ethylene) stream is pressurized via mechanical compressor to above reaction pressure. The solvent and comonomer (1-octene) feed are pressurized via a mechanical positive displacement pump to above reaction pressure. MMAO-3A, commercially available from Nouryon, was used as an impurity scavenger. The individual catalyst components (27 recatalyst or cocatalyst) were manually batch diluted to specified component concentrations with purified solvent (Isopar E) and pressured to above reaction pressure. The cocatalyst is [HNMe(C₁₈H₃₇)]₂ [B(C₆F₅)₄], commercially available from Boulder Scientific, and is used at a 1.2 ratio to catalyst metal unless otherwise specified. All reaction feed flows were measured with mass flow meters and independently controlled with computer automated valve control systems.

The continuous solution polymerizations were carried out in one or more of a CSTR, loop, and/or a plug flow reactor. The CSTR and loop reactors have independent control of all fresh solvent, monomer, comonomer, hydrogen, and catalyst component feeds. The plug flow reactor has independent control of catalyst component feeds. The combined solvent, monomer, comonomer and hydrogen feed to the reactors is temperature controlled to anywhere between 5° C. to 50° C. and typically 25° C. The fresh comonomer feed to the polymerization reactor is fed in with the solvent feed. The fresh solvent feed is controlled typically with each injector receiving half of the total fresh feed mass flow. The cocatalyst is fed based on a calculated specified molar ratio to the procatalysts. Immediately following each fresh injection location, the feed streams are mixed with the circulating polymerization reactor contents with static mixing elements. The ratio of the catalyst feeds is adjusted to obtain the desired polymer MI, density, and melt strength. The effluent from the polymerization reactor system (containing solvent, monomer, comonomer, hydrogen, catalyst components, and molten polymer) exits and passes through a control valve (responsible for maintaining the pressure of the reactor system at a specified target). As the stream exits the reactor it is contacted with water to stop the reaction. In addition, various additives, such as antioxidants, could be added at this point. The stream then goes through another set of static mixing elements to evenly disperse the catalyst kill and additives.

Following additive addition, the effluent (containing solvent, monomer, comonomer, hydrogen, catalyst components, and molten polymer) passes through a heat exchanger to raise the stream temperature in preparation for separation of the polymer from the other lower boiling reaction components. The stream then entered a two-stage separation and devolatization system where the polymer was removed from the solvent, hydrogen, and unreacted monomer and comonomer. The separated and devolatized polymer melt was pumped through a die specially designed for underwater pelletization, cut into uniform solid pellets, dried, and transferred into a box for storage.

### Procedure for Polymerization in a Continuous Reactor: Setup 2

All raw materials (monomer and comonomer) and the process solvent (a narrow boiling range high-purity isoparaffinic solvent, Isopar-E) are purified with molecular sieves before introduction into the reaction environment. Hydrogen is supplied pressurized as a high purity grade and is not further purified. The reactor monomer feed stream is pressurized via a mechanical compressor to above reaction pressure. The solvent and comonomer feed is pressurized via a pump to above reaction pressure. The individual catalyst components are manually batch diluted with purified solvent and pressured to above reaction pressure. All reaction feed flows are measured with mass flow meters and independently controlled with computer automated valve control systems.

A two reactor system is used in a series configuration. The first reactor is a continuous solution polymerization reactor consisting of a liquid full, adiabatic, continuously stirred tank reactor (CSTR). Independent control of all fresh solvent, monomer, comonomer, hydrogen, and catalyst component feeds is possible. The total fresh feed stream to the second reactor (solvent, monomer, comonomer, and hydrogen) is temperature controlled to maintain a single solution phase by passing the feed stream through a heat exchanger. The total fresh feed to the second polymerization reactor is injected into the reactor at one location. The catalyst components are injected into the second polymerization reactor separate from the fresh feed. The primary catalyst component feed is computer controlled to maintain the reactor monomer conversion at the specified value. The cocatalyst component(s) is/are fed based on molar ratios to the primary catalyst component. Mixing of the second reactor is provided by an agitator. The effluent from the first polymerization reactor (containing solvent, monomer, comonomer, hydrogen, catalyst components, and polymer) exits the first reactor loop and is added to the second reactor separate from the fresh feed and separate from the catalyst feed components.

The second reactor is a continuous solution polymerization reactor consisting of a liquid full, non-adiabatic, isothermal, circulating, loop reactor which mimics a continuously stirred tank reactor (CSTR) with heat removal. Independent control of all fresh solvent, monomer, comonomer, hydrogen, and catalyst component feeds is possible. The total fresh feed stream to the first reactor (solvent, monomer, comonomer, and hydrogen) is temperature controlled to maintain a single solution phase by passing the feed stream through a heat exchanger. The total fresh feed to the first polymerization reactor is injected into the reactor at two locations with approximately equal reactor volumes between each injection location. The fresh feed is controlled with each injector receiving half of the total fresh feed mass flow. The catalyst components are injected into the polymerization reactor separate from the fresh feeds. The primary catalyst component feed is computer controlled to maintain the reactor monomer conversion at the specified value, and to produce a polymer with a desired MI, density, and melt strength. The cocatalyst component(s) is/are fed based on molar ratios to the primary catalyst component. Immediately following each first reactor feed injection location, the feed streams are mixed with the circulating polymerization reactor contents with static mixing elements. The contents of the first reactor are continuously circulated through heat exchangers responsible for removing much of the heat of reaction and with the temperature of the coolant side responsible for maintaining an isothermal reaction environment at the specified temperature. Circulation around the first reactor loop is provided by a pump.

The second reactor effluent enters a zone where it is deactivated with the addition of and reaction with a suitable reagent (water). Antioxident addition can also occur at this same addition point. Following catalyst deactivation and additive addition, the reactor effluent enters a devolatization system where the polymer is removed from the non-polymer stream. The isolated polymer melt is pelletized and collected. The non-polymer stream passes through various pieces of equipment which separate most of the ethylene which is removed from the system. Most of the solvent and unreacted comonomer is recycled back to the reactor after passing through a purification system. A small amount of solvent and comonomer is purged from the process.

The reactor stream feed data flows that correspond to the values in Table 2. The data are presented such that the complexity of the solvent recycle system is accounted for and the reaction system can be treated more simply as a once through flow diagram.

### EXAMPLES

One or more features of the present disclosure are illustrated in view of the examples as follows.

The following catalysts were utilized in one or more of the examples described subsequently in more detail:

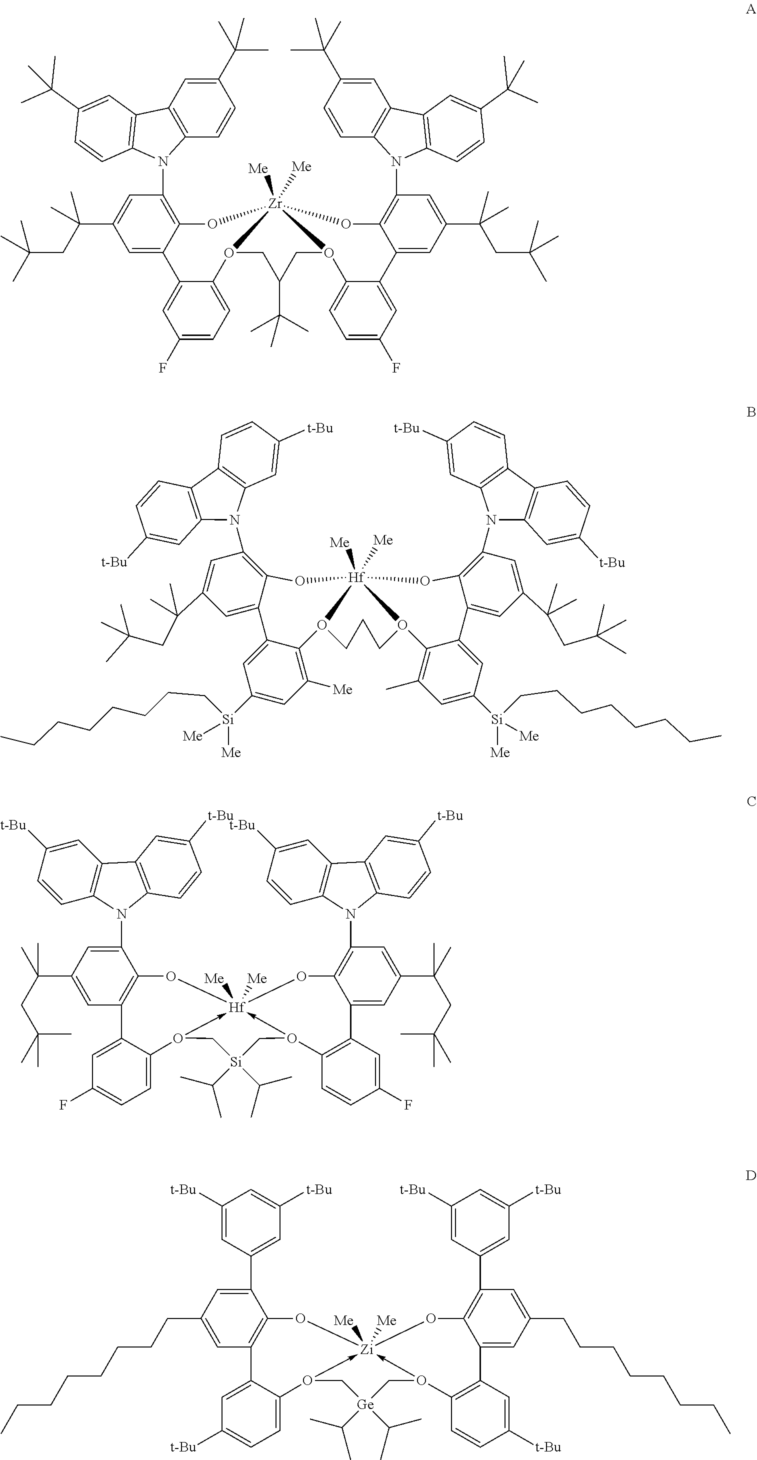

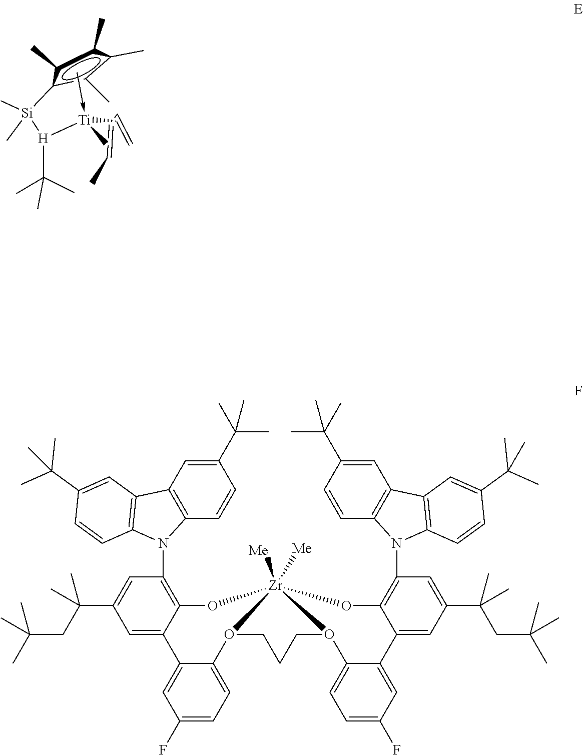

### Example 1: Preparation of Compositions 1-8

Multimodal Ethylene-based Polymer Compositions 1-8, which are described according to the one or more embodiments of the detailed description, were prepared by a process utilizing the catalysts and reactors described below. The reactor and feed conditions for the synthesis of Compositions 1-8 are provided in Table 1 and Composition 9 in Table 2.

TABLE 1
Reactor and Feed Conditions for the Synthesis of Compositions 1-8.

| | Multimodal Ethylene-based Polymer Composition | | | | | | | |
|---|---|---|---|---|---|---|---|---|
| | 1 | 2 | 3 | 4 | 5 | 6 | 7 | 8 |
| Reactor | 1 | 1 | 1 | 1 | 1 | 1 | 1 | 1 |
| setup | | | | | | | | |
| Reactor | Single | Single | Single | Single | Single | Single | Single | Single |
| Conf. | | | | | | | | |
| Comonomer | 1-octene | 1-octene | 1-octene | 1-octene | 1-octene | 1-octene | 1-octene | 1-octene |
| Type | | | | | | | | |
| Catalyst 1 | A | A | A | A | A | A | A | A |
| Catalyst 2 | C | C | D | C | C | D | D | C |
| Catalyst 1 | 0.025 | 0.025 | 0.05 | 0.025 | 0.025 | 0.025 | 0.025 | 0.025 |
| Feed Con. | | | | | | | | |
| (mmol/kg) | | | | | | | | |
| Catalyst 1 | 375 | 375 | 295 | 87 | 86 | 79 | 84 | 82 |
| Flow (g/hr) | | | | | | | | |
| Catalyst 2 | 0.075 | 0.075 | 0.1 | 0.075 | 0.075 | 0.04 | 0.04 | 0.075 |
| Feed Con. | | | | | | | | |
| (mmol/kg) | | | | | | | | |
| Catalyst 2 | 75 | 99 | 375 | 22 | 29 | 60 | 100 | 31 |
| Flow (g/hr) | | | | | | | | |
| Total Solvent | 37 | 37.1 | 37.2 | 33.3 | 33.3 | 33.2 | 33.1 | — |
| Flow (kg/hr) | | | | | | | | |
| Reactor 1 | 190 | 190 | 190 | 165 | 165 | 165 | 165 | 165 |
| Temp (° C.) | | | | | | | | |
| Reactor 1 C2 | 4.72 | 4.72 | 4.72 | 4.5 | 4.5 | 1.5 | 4.5 | 4.5 |
| Feed (kg/hr) | | | | | | | | |
| Reactor C8 | 1.3 | 1.3 | 1.3 | 1.53 | 1.53 | 1.53 | 1.53 | 1.53 |
| Feed (kg/hr) | | | | | | | | |
| Reactor 1 H2 | 5 | 5 | 5 | 15 | 27 | 15 | 26 | 27 |
| Feed (sccm) | | | | | | | | |
| Reactor 1 | 3 | 3 | 3 | 6 | 6 | 6 | 6 | 6 |
| Exit [C2] | | | | | | | | |
| (g/L) | | | | | | | | |
| Reactor 1 | 4.3 | 4.3 | 4.3 | 4.9 | 4.9 | 4.9 | 4.9 | 4.9 |
| residence | | | | | | | | |
| time (min) | | | | | | | | |
| Percent | 13 | 12 | 13 | 13 | 13 | 13 | 13 | 13 |
| solids (%) | | | | | | | | |

TABLE 2
Reactor and Feed Conditions for the Synthesis of Composition 9.

| Parameter | units | 15 |
|---|---|---|
| Reactor setup | Type | 2 |
| Comonomer type | Type | 1-octene |
| First Reactor Feed Solvent/Ethylene | g/g | 5.5 |
| Mass Flow Ratio | | |
| First Reactor Feed Comonomer/Ethylene | g/g | 0.217 |
| Mass Flow Ratio | | |
| First Reactor Feed Hydrogen/Ethylene | g/g | 3.3E−05 |
| Mass Flow Ratio | | |
| First Reactor Temperature | ° C. | 187 |
| First Reactor Pressure | barg | 41 |
| First Reactor Ethylene Conversion | % | 85.9 |
| First Reactor Catalyst-1 Type | Type | A |
| First Reactor Co-Catalyst 1 Type | Type | [HNMe(C₁₈H₃₇)]₂ |
| | | [B(C₆F₅)₄] |
| First Reactor Co-Catalyst 2 Type | Type | MMAO-3A |
| First Reactor Co-Catalyst 1 to | Ratio | 1.1 |
| Catalyst Molar Ratio | | |
| First Reactor Co-Catalyst 2 to | Ratio | 117.1 |
| Catalyst Molar Ratio | | |
| First Reactor Residence Time | min | 6.4 |
| Percentage of Total Ethylene Feed | wt % | 99.3 |
| to First Reactor | | |
| Second Reactor Feed Solvent/Ethylene | g/g | 95.1 |
| Mass Flow Ratio | | |
| Second Reactor Feed Comonomer/Ethylene | g/g | 1.62 |
| Mass Flow Ratio | | |
| Second Reactor Feed Hydrogen/Ethylene | g/g | 0 |
| Mass Flow Ratio | | |
| Second Reactor Temperature | ° C. | 190 |
| Second Reactor Pressure | barg | 42 |
| Second Reactor Ethylene Conversion | % | 60.5 |
| Second Reactor Catalyst Type | Type | C |
| Second Reactor Co-Catalyst 1 Type | Type | [HNMe(C₁₈H₃₇)]₂ |
| | | [B(C₆F₅)₄] |
| Second Reactor Co-Catalyst 2 Type | Type | None |
| Second Reactor Co-Catalyst 1 to | Ratio | 116.0 |
| Catalyst Molar Ratio | | |
| Second Reactor Co-Catalyst 2 to | Ratio | N/A |
| Catalyst Molar Ratio | | |
| Second Reactor Residence Time | min | 5.9 |

### Example 2: Preparation of Comparative Compositions C₁-C₃

Comparative Compositions C₁-C₃ were prepared by a process utilizing the catalysts and reactors described below.

All raw materials (monomer and comonomer) and the process solvent (a narrow boiling range high-purity isoparaffinic solvent, Isopar-E) were purified with molecular sieves before introduction into the reaction environment. Hydrogen was supplied pressurized as a high purity grade and was not further purified. The reactor monomer feed stream was pressurized via a mechanical compressor to above reaction pressure. The solvent and comonomer feed was pressurized via a pump to above reaction pressure. The individual catalyst components were manually batch diluted with purified solvent and pressured to above reaction pressure. All reaction feed flows were measured with mass flow meters and independently controlled with computer automated valve control systems. The reactor and feed conditions for the synthesis of Comparative Compositions C₁-C₃ are provided in Table 3.

TABLE 3
Reactor and Feed Conditions for the
Synthesis of Comparative Comp. C1-C3.

| Comparative Ethylene-based | | | |
|---|---|---|---|
| Polymer Composition | C1 | C2 | C3 |
| Reactor setup | 1 | 1 | 1 |
| Reactor Conf. | Single | Single | Single |
| Comonomer Type | 1-octene | 1-octene | 1-octene |
| Catalyst 1 | A | A | A |
| Catalyst 2 | — | — | — |
| Catalyst 1 Feed Con. (mmol/kg) | 0.025 | 0.025 | 0.05 |
| Catalyst 1 Flow (g/hr) | 125 | 375 | 129 |
| Catalyst 2 Feed Con. (mmol/kg) | — | — | — |
| Catalyst 2 Flow (g/hr) | — | — | — |
| Total Solvent Flow (kg/hr) | 33.4 | 37 | 36.8 |
| Reactor 1 Temp (° C.) | 165 | 190 | 179 |
| Reactor 1 C2 Feed (kg/hr) | 4.5 | 4.72 | 4.72 |
| Reactor C8 Feed (kg/hr) | 1.53 | 1.3 | 1.15 |
| Reactor 1 H2 Feed (sccm) | 15 | 5 | 5 |
| Reactor 1 Exit [C2] (g/L) | 6 | 3 | 3 |
| Residence time (min) | 4.9 | 4.3 | 4.4 |
| Percent solids (%) | 13 | 13 | 13 |

### Example 3: Comparative Compositions C4-C8

Table 4 identifies the commercially-available Comparative Compositions C4-C8.

TABLE 4
Commercially-available Comparative Compositions C4-C8.

| Comparative | Commercial Name (Company of |
|---|---|
| Composition | Manufacture) |
| C4 | Agility 1021 (Dow Chemical Co.) |
| C5 | Agility 1200 (Dow Chemical Co.) |
| C6 | Dowlex 2045 (Dow Chemical Co.) |
| C7 | Innate ST70 (Dow Chemical Co.) |
| C8 | Elite 5400 (Dow Chemical Co.) |

### Example 4: Preparation of Comparative Compositions C9-C19

Comparative Compositions 9-19 were prepared by a process utilizing the catalysts and reactors described below.

TABLE 4
Reactor and Feed Conditions for the Synthesis of Comparative Comp. C9-C19.

| | C9 | C10 | C11 | C12 | C13 | C14 | C15 | C16 | C17 | C18 | C19 |
|---|---|---|---|---|---|---|---|---|---|---|---|
| Reactor | Dual | Dual | Dual | Dual | Dual | Dual | Dual | Dual | Dual | Dual | Dual |
| Conf. | | | | | | | | | | | |
| Reactor | 1 | 1 | 1 | 1 | 1 | 1 | 1 | 1 | 1 | 1 | 1 |
| setup | | | | | | | | | | | |
| Comonomer | 1-octene | 1-octene | 1-octene | 1-octene | 1-octene | 1-octene | 1-octene | 1-octene | 1-octene | 1-octene | 1-octene |
| Type | | | | | | | | | | | |
| Reactor 1 | 123 | 160 | 160 | 210 | 210 | 210 | 210 | 210 | 210 | 225 | 225 |
| Temp (° C.) | | | | | | | | | | | |
| Reactor 1 | 20.6 | 29.8 | 29.7 | 15.5 | 15.5 | 15.5 | 15.5 | 15.8 | 15.8 | 15.8 | 15.8 |
| Solvent | | | | | | | | | | | |
| Feed (kg/h) | | | | | | | | | | | |
| Reactor 1 | 3.41 | 1.2 | 1.2 | 2.57 | 2.57 | 2.57 | 2.57 | 2.52 | 2.52 | 2.52 | 2.52 |
| C2 Feed | | | | | | | | | | | |
| (kg/hr) | | | | | | | | | | | |
| Reactor 1 | 1.01 | 0.9 | 0.9 | 1.2 | 1.2 | 1.2 | 1.2 | 1.05 | 1.05 | 1.05 | 1.05 |
| C8 Feed | | | | | | | | | | | |
| (kg/hr) | | | | | | | | | | | |
| Reactor 1 | 11 | 0 | 4 | 19 | 19 | 19 | 19 | 4 | 4 | 4 | 4 |
| H2 Feed | | | | | | | | | | | |
| (sccm) | | | | | | | | | | | |
| Reactor 1 | 22.2 | 13 | 13 | 2.13 | 2.13 | 1.8 | 1.98 | 1.82 | 1.82 | 2 | 1.7 |
| Exit [C2] | | | | | | | | | | | |
| (g/L) | | | | | | | | | | | |
| Reactor 2 | 190 | 160 | 160 | 170 | 170 | 170 | 170 | 170 | 170 | 170 | 170 |
| Temp (° C.) | | | | | | | | | | | |
| Reactor 2 | 10 | 19.3 | 19.6 | 20.2 | 20.2 | 9 | 9 | 15.6 | 15.6 | 15.5 | 15.5 |
| Solvent | | | | | | | | | | | |
| Feed (kg/h) | | | | | | | | | | | |
| Reactor 2 | 2.12 | 4.7 | 4.7 | 3.84 | 3.84 | 1.7 | 1.7 | 2.96 | 2.96 | 2.96 | 2.96 |
| C2 Feed | | | | | | | | | | | |
| (kg/hr) | | | | | | | | | | | |
| Reactor 2 | 0.4 | 0.55 | 0.35 | 0.67 | 0.67 | 0.1 | 0.1 | 0.64 | 0.62 | 0.53 | 0.53 |
| C8 Feed | | | | | | | | | | | |
| (kg/hr) | | | | | | | | | | | |
| Reactor 2 | 200 | 420 | 270 | 455 | 455 | 260 | 300 | 364 | 310 | 299 | 300 |
| H2 Feed | | | | | | | | | | | |
| (sccm) | | | | | | | | | | | |
| Reactor 2 | 4.91 | 13.1 | 13.2 | 2.95 | 2.95 | 2.7 | 3.37 | 2.23 | 2.23 | 1.4 | 1.44 |
| Exit [C2] | | | | | | | | | | | |
| (g/L) | | | | | | | | | | | |
| Catalyst 1 | E | D | D | F | F | F | F | A | A | A | A |
| Catalyst 2 | — | — | — | — | — | — | — | — | — | — | — |
| Catalyst 3 | B | D | D | C | C | C | C | C | C | C | C |
| Catalyst 1 | 0.34 | 0 | 0 | 0.2 | 0.2 | 0.2 | 0.2 | 0.2 | 0.2 | 0.2 | 0.2 |
| Feed Conc. | | | | | | | | | | | |
| (mmol/kg) | | | | | | | | | | | |
| Catalyst 1 | 60 | 186 | 154 | 143 | 143 | 125 | 193 | 144 | 171 | 210 | 200 |
| Flow (g/hr) | | | | | | | | | | | |
| Catalyst 2 | — | — | — | — | — | — | — | — | — | — | — |
| Feed Conc. | | | | | | | | | | | |
| (mmol/kg) | | | | | | | | | | | |
| Catalyst 2 | — | — | — | — | — | — | — | — | — | — | — |
| Flow (g/hr) | | | | | | | | | | | |
| Catalyst 3 | 0.02 | — | — | 0.2 | 0.2 | 0.2 | 0.2 | 0.2 | 0.2 | 0.2 | 0.2 |
| Feed Conc. | | | | | | | | | | | |
| (mmol/kg) | | | | | | | | | | | |
| Catalyst 3 | 45 | — | — | 141 | 141 | 107 | 114 | 123 | 130 | 256 | 270 |
| Flow (g/hr) | | | | | | | | | | | |

### Example 5: Analysis of Compositions 1-8 and Comparative Compositions 1-19

In Example 5, the Multimodal Ethylene-based Polymer Compositions 1-8 and Comparative Compositions 1-19 were tested for the properties listed in Tables 6-8, according to the test methods described herein.

TABLE 6
Analysis of Compositions 1-8 and Comparative Compositions 1-19.

| | | Mn* | Mw* | Mz* | Mw/ | Mz/ | | | | Mw_{(abs)}/ |
|---|---|---|---|---|---|---|---|---|---|---|
| | Catalyst | (kDa) | (kDa) | (kDa) | Mn* | Mw** | Mn** | Mw** | Mz** | Mw_{(GPC)} |
| C1 | A | 20.2 | 64.7 | 193.4 | 2.6 | 2.7 | 20.3 | 53.2 | 141.5 | 1.21 |
| C2 | A | 18.7 | 62.1 | 160 | 2.7 | 2.4 | 18.8 | 50.7 | 121.2 | 1.21 |
| C3 | A | 22.7 | 77.9 | 185.8 | 2.8 | 2.3 | 22.8 | 63.2 | 146.1 | 1.22 |
| C4 | — | 12.5 | 251.4 | 941.6 | 8.8 | 4.8 | 12.2 | 107.6 | 514.1 | 2.32 |
| C5 | — | 15 | 401.9 | 1075 | 11.5 | 4.5 | 14.4 | 165.6 | 738.5 | 2.42 |
| C6 | Ziegler- | 24.9 | 119.6 | 444.5 | 4.6 | 4 | 26.1 | 120.6 | 484.3 | 0.99 |
| | Natta | | | | | | | | | |
| C9 | E/B | 45.2 | 111.3 | 228.4 | 2.3 | 2.1 | 46.1 | 106.8 | 219.5 | 1.04 |
| C10 | D/D | 33.1 | 118.1 | 1095 | 3.7 | 13.6 | 33.3 | 124.5 | 1692 | 0.96 |
| C11 | D/D | 50 | 136.4 | 645.7 | 2.8 | 6.4 | 48.6 | 135.8 | 874.4 | 1 |
| C12 | F/C | 27.2 | 89 | 299.1 | 2.8 | 2 | 25.6 | 72.6 | 147.2 | 1.23 |
| C13 | F/C | 28.7 | 88.8 | 280.6 | 2.8 | 2 | 25.5 | 72.1 | 143.2 | 1.23 |
| C14 | F/C | 25.4 | 93.4 | 348.6 | 3.1 | 2.2 | 24 | 75.2 | 162.3 | 1.24 |
| C15 | F/C | 26.3 | 89.1 | 310 | 2.9 | 2.1 | 24.2 | 70.9 | 146.6 | 1.26 |
| C16 | A/C | 20.8 | 87.3 | 237.7 | 3.5 | 2 | 19.6 | 68.5 | 139.8 | 1.27 |
| C17 | A/C | 20 | 89.9 | 242 | 3.7 | 2.1 | 18.9 | 70.1 | 149 | 1.28 |
| C18 | A/C | 20.6 | 88.4 | 208.1 | 3.5 | 2 | 20.1 | 69.8 | 138.8 | 1.27 |
| C19 | A/C | 22.6 | 88.1 | 200.6 | 3.3 | 2 | 21 | 69.8 | 136.7 | 1.26 |
| 1 | A/C | 20.4 | 85.2 | 327.6 | 3.5 | 4.3 | 19.9 | 69.2 | 299.8 | 1.23 |
| 2 | A/C | 20.1 | 98.4 | 429.5 | 4 | 5.2 | 20.4 | 81.5 | 421.5 | 1.21 |
| 3 | A/D | 21 | 83.7 | 242.5 | 3.3 | 3.3 | 21.3 | 70.2 | 229.5 | 1.19 |
| 4 | A/C | 21.6 | 90.5 | 529.2 | 3.5 | 6.6 | 21.4 | 75.3 | 499 | 1.2 |
| 5 | A/C | 20.4 | 99.5 | 628.3 | 4.1 | 7.1 | 20.2 | 82.5 | 584.7 | 1.2 |
| 6 | A/D | 22 | 82.5 | 360.5 | 3.3 | 4.8 | 21.4 | 71.1 | 342.1 | 1.16 |
| 7 | A/D | 20.8 | 83.9 | 339.7 | 3.4 | 4.3 | 20.8 | 71 | 305.2 | 1.19 |
| 8 | A/C | 20.5 | 104.2 | 661.5 | 4.2 | 7.2 | 20.3 | 85.8 | 613.9 | 1.22 |
| 9 | A/C | 18.8 | 93.8 | 496.5 | 5.0 | 5.3 | 20.6 | 78.6 | 281.8 | 1.2 |

*Values from absolute GPC analysis
**Values from conventional GPC analysis

TABLE 7
Analysis of Compositions 1-8 and
Comparative Compositions 1-19.

| | Catalyst | C8 wt % | Density (g/cc) | LCBf | V0.1/V100 |
|---|---|---|---|---|---|
| C1 | A | 18 | 0.9058 | 0.685 | 4 |
| C2 | A | 16.4 | 0.9076 | 0.767 | 3.7 |
| C3 | A | 15.2 | 0.9095 | 0.746 | 9.7 |
| C4 | — | — | 0.92 | 1.35 | 49 |
| C5 | — | — | 0.919 | 1.639 | 21 |
| C6 | Ziegler-Natta | 8.1 | 0.92 | 0.000 | 5 |
| C7 | Molecular | 7.9 | 0.9225 | 0.045 | 6.4 |
| C8 | Molecular | 11.4 | 0.916 | 0.077 | 6.8 |
| C9 | E/B | 7.1 | 0.9243 | 0 | 4.7 |
| C10 | C/C | 8.1 | 0.9197 | 0 | 6.2 |
| C11 | C/C | 6.8 | 09176 | 0 | 4.5 |
| C12 | F/C | — | 0.9048 | 0.049 | 15.2 |
| C13 | F/C | — | 0.9045 | 0.164 | 14.8 |
| C14 | F/C | — | 0.9049 | 0.138 | 19.6 |
| C15 | F/C | — | 0.9043 | 0.196 | 15.4 |
| C16 | A/C | — | 0.9041 | 0.192 | 17.0 |
| C17 | A/C | — | 0.9044 | 0.173 | 19.3 |
| C18 | A/C | — | 0.9035 | 0.071 | 18.6 |
| C19 | A/C | — | 0.9038 | 0.115 | 16.4 |
| 1 | A/B | 16.3 | 0.9078 | 0.828 | 16 |
| 2 | A/B | 16.2 | 0.908 | 0.727 | 22 |
| 3 | A/C | 16.2 | 0.9075 | 0.786 | 18 |
| 4 | A/B | 17.5 | 0.9065 | 0.547 | 12 |
| 5 | A/B | 17.6 | 0.905 | 0.568 | 17 |
| 6 | A/C | 17.4 | 0.9053 | 0.606 | 14 |
| 7 | A/C | 17.4 | 0.9066 | 0.535 | 18 |
| 8 | A/B | 17.5 | 0.9065 | 0.538 | 16 |
| 9 | A/C | 11.0 | 0.9171 | 0.439 | 18.1 |

TABLE 8
Analysis of Compositions 1-8 and Comparative Compositions 1-19.

| | | | | | | Vinyl end | | |
|---|---|---|---|---|---|---|---|---|
| | | CDF LS | | | | group | | |
| | | 500,000 | Melt | | Activation | count | | |
| | | g/mol | strength | Drawability | Energy | per 1000 | | |
| | Catalyst | cutoff % | (cN) | (mm/s) | (kJ/mol) | C | MI | I10/12 |
| C1 | A | 7.3 | 2.7 | 243 | 49 | — | 6.5 | 10.7 |
| C2 | A | 5.7 | 1.3 | 259 | 50 | 0.545 | 8.0 | 10.4 |
| C3 | A | 5.2 | 4.3 | 221 | 53 | 0.464 | 1.8 | 12.8 |
| C4 | — | 53.2 | 8.0 | 230 | 52 | — | 1.85 | 14.5 |
| C5 | — | 62.8 | 22.0 | 60 | 48 | — | 0.23 | 17.3 |
| C6 | Ziegler-Natta | 24.5 | 3.2 | 215 | 30 | — | 1.0 | 8.2 |
| C7 | Molecular | 16.1 | 4.1 | 207.5 | 33.2 | — | 0.85 | 8 |
| C8 | Molecular | 13.9 | 4.1 | 164.0 | 36.3 | — | 1.0 | 8.5 |
| C9 | E/B | 7.1 | 4.3 | 181 | 32 | 0.036 | 0.86 | 7.1 |
| C10 | D/D | 44.0 | 2.2 | 150 | 33.3 | 0.012 | 3.68 | 6.8 |
| C11 | D/D | 28.9 | 3.9 | 196 | 31.0 | 0.018 | 0.99 | 6.7 |
| C12 | F/C | 4.78 | 4.1 | 253 | 49.6 | 0.112 | 0.80 | 14.3 |
| C13 | F/C | 4.96 | 4.2 | 240 | 49.9 | 0.11 | 0.85 | 14.2 |
| C14 | F/C | 6.18 | 5.3 | 232 | 53.4 | 0.156 | 0.62 | 16.1 |
| C15 | F/C | 5.18 | 4.4 | 254 | 53.3 | 0.14 | 0.91 | 14.8 |
| C16 | A/C | 2.75 | 5.3 | 259 | 54.4 | 0.249 | 0.94 | 15.3 |
| C17 | A/C | 3.69 | 5.3 | 260 | 55.1 | 0.293 | 0.90 | 16.0 |
| C18 | A/C | 2.13 | 5.7 | 266 | 54.4 | 0.225 | 0.69 | 15.8 |
| C19 | A/C | 2.12 | 6.2 | 266 | 54.3 | 0.190 | 0.77 | 15.3 |
| 1 | A/B | 20.5 | 19.5 | 125 | 51 | 0.521 | 1.92 | 14.6 |
| 2 | A/B | 27.8 | 26.5 | 96 | 52 | 0.520 | 0.9 | 19.0 |
| 3 | A/C | 11.0 | 11.1 | 163 | 52 | 0.485 | 1.03 | 16.1 |
| 4 | A/B | 31.2 | 34.0 | 49 | 50 | 0.512 | 1.85 | 13.7 |
| 5 | A/B | 39.5 | 32.6 | 53 | 49 | 0.514 | 1.68 | 14.8 |
| 6 | A/C | 22.7 | 16.5 | 107 | 50 | 0.496 | 1.71 | 14.9 |
| 7 | A/C | 22.2 | 11.7 | 131 | 50 | 0.495 | 1.74 | 15.5 |
| 8 | A/B | 41.6 | 36.0 | 52.0 | 47 | 0.505 | 1.45 | 11.1 |
| 9 | A/C | 23 | 15.5 | 87 | 51 | 0.596 | 13.8 | 13.8 |

As shown in Tables 6-8, Samples 1-9 exhibited improved melt strength in comparison to Comparative Samples C1-C19. C1-C3, C9, and C12-C19 all failed to exhibit enough high molecular weight fraction, computed by the area fraction of the MWD greater than 500,000 g/mol as obtained by absolute molecular weights from GPC light scattering analysis. Additionally, Comparative Samples C4-C5 exhibited a high molecular weight fraction of greater than 50% of the area fraction of the MWD greater than 500,000 g/mol as obtained by absolute molecular weights from light scattering. Additionally, Samples 1-8 exhibited higher amount of vinyl end groups per 1000 carbon atoms when compared to Comparative Examples C12-C19. The increase in the number of vinyl end group count correlates to the increase in long chain branching frequency. Additionally, Samples 1-8 exhibited I10/I2 (melt flow ratio) comparable to or higher than the I10/I2 of C1-C19, which is indicative of the resins' comparable or improved processability, respectively. Long chain branching is present in both Samples 1-8 and Comparative Samples C1-C3) in comparable quantities; however, only Samples 1-8, having high molecular weight component described herein, exhibited improved melt strength and melt flow ratio. Similarly, both Samples 1-9 and Comparative Samples C1-C3 have similar LCBf, but only Samples 1-9, having high molecular weight component described herein, exhibited improved melt strength.

1. A process of making a multimodal ethylene-based copolymer, comprising:
contacting ethylene and at least one olefinic monomer in the presence of at least a first catalyst system to produce a bulk low molecular weight component and a second catalyst system to produce a high molecular weight component in a solution polymerization reactor system at a reactor temperature of greater than or equal to 150° C.;
wherein the multimodal ethylene-based copolymer comprises:
a long chain branching frequency of from 0.3-1.0;
a melt index of from 0.5 g/10 minutes (g/10 min) to 10.0 g/10 min, when measured according to ASTM D-1238 at 190° C. and 2.16 kg; and
a high molecular weight fraction, computed by measuring an area fraction of a molecular weight distribution obtained from absolute molecular weights from low angle light scattering greater than 500,000 g/mol using GPC molecular weight distribution, of from 8% to 50% based on the total percent of the multimodal ethylene-based copolymer.

2. The process of claim 1, wherein the composition as determined from dynamic mechanical analysis has an activation energy (Ea) of greater than 47 kJ/mol.

3. The process of claim 1, wherein the multimodal ethylene-based copolymer further comprises a low molecular weight fraction, computed by measuring an area fraction of a molecular weight distribution obtained from absolute molecular weights from low angle light scattering less than 500,000 g/mol using GPC molecular weight distribution, is greater than or equal to 50% based on the total percent of the multimodal ethylene-based copolymer.

4. The process of claim 1, wherein the amount of long-chain branching derived from the concentration of vinyl groups in the multimodal ethylene-based copolymer produced expressed in vinyls/1,000 carbon atoms is from 0.475 to 0.600.

5. The process of claim 1, wherein the first catalyst system has a first catalyst efficiency of from 1,000 kg polymer/g metal to 100,000 kg polymer/g metal.

6. The process of claim 1, wherein the second catalyst has a second catalyst efficiency of from 1,000 kg polymer/g metal to 100,000 kg polymer/g metal.

7. The process of claim 1, wherein the solution polymerization reactor system comprises a single reactor.

8. The process of claim 1, where the solution polymerization reactor system comprises a first reactor and a second reactor.

9. The process of claim 1, wherein the second catalyst has reactivity ratio of less than 20.

10. The process of claim 1, wherein the multimodal ethylene-based copolymer has a density of from 0.900 g/cc to 0.940 g/cc measured according to ASTM D792.

11. The process of claim 1, wherein the multimodal ethylene-based copolymer has a melt strength of at least 5 cN and a melt index (12) of at least 0.5 g/10 minutes measured according to ASTM 1238 at 2.16 kg and 190° C.

12. The process of claim 1, wherein the multimodal ethylene-based copolymer has a melt strength (MS) that satisfies the following formula:
$$M S = \frac{x}{{I}_{2}} + y$$
wherein x is greater than or equal to 8, y is greater than or equal to 3, and 12 is a melt index of the copolymer measured according to ASTM 1238 at 2.16 kg and 190° C.

13. The process of claim 1, where the V0.1/V100 value as determined by dynamic mechanical analysis is greater than 10.

14. The process of claim 1, wherein the first reactor temperature is from 160° C. to 200° C.
